(19) United States
(12) Patent Application Publication
(10) Pub. No.: US 2024/0154523 A1
(43) Pub. Date: May 9, 2024

(54) A DEVICE FOR POWER TRANSFORMATION AND PHOTONIC IRRADIATION

(71) Applicant: SPECTRALWATT PTY LTD, Erskineville, New South Wales (AU)

(72) Inventor: Donald WILLIAMS, Woodford (AU)

(73) Assignee: SPECTRALWATT PTY LTD, Erskineville, New South Wales (AU)

(21) Appl. No.: 18/281,433

(22) PCT Filed: Mar. 11, 2022
(86) PCT No.: PCT/AU2022/050198

§ 371 Date: Sep. 11, 2023

(30) Foreign Application Priority Data
Mar. 11, 2021 (AU) 2021900707

(51) Int. Cl. H02M 1/42; H02M 7/217; H05B 45/36; H05B 45/3725; H05B 45/48

(52) U.S. Cl. CPC H02M 1/4241; H02M 7/2176; H05B 45/36; H05B 45/3725; H05B 45/48

(57) ABSTRACT

The innovation specified herein effects optimal power transfer at power factor approaching unity for varying loads. The Luminaire load example embodiment can emit high power photo-flux radiance constructed by resonance while exhibiting a high degree of parametric autoregulation providing enhanced luminaire reliability with minimal semiconductor components and optimal EMC compliance. One application of such autoregulation exploits a contrived dark phase of zero LED current and consequent zero photoflux to exploit zero current switching between columns of different wavelengths for say, Visual light communications, fluorometry and insolation emulation for horticulture, polymer science, or other photochemistry. LED emitters so employed are driven by sinusoidal current waveforms which have advantageous high peak photoflux density in comparison to DC drive for the same heat dissipation and when arranged in X-Y arrays correctly regulate column current distribution for amplitude modulation or for avoiding failure cascade after element failure.

### FIELD OF THE INVENTION

One or more embodiments of the disclosed invention herein are applied to general lighting including the more demanding of irradiated photonic power and controllability required for horticulture photosynthesis. The topology for the device, and embodiments of the device disclosed herein function as a power transformation device suited to more general High Frequency Alternating Current (HFAC) power distribution networks as a means of regulating current or voltage supplies. The photon production of this disclosure, over a wide wavelength range from deep UV-C to far infrared, is also suited to the various requirements of photo-chemical application in plastics for curing and hydrocarbon polymer synthesis or other manipulation of photochemistry or dissolution of plastics for recycling or other such duties for recycling materials or as an irradiator process effecting cytotoxicity in gas or fluids or to function in bio-reactors or filtration. All processes executing cytotoxicity, bio-synthesis, carbon reduction and other filtration systems requiring irradiation are benefitted by this manner of photon production allowing power reduction or provision of radiant spectral line flux density peak greater than that provided by DC wide spectrum drive, while at reduced duty cycles incurring lower heat dissipation.

### BACKGROUND OF THE INVENTION

The present global distribution of electrical power is reliant on Low Frequency Alternating Current (LFAC) of 50 Hz or other lethal LFAC frequencies at a variety of lethal to human voltages such as 440 Vrms (440 Vac), 110 Vrms, 240 Vrms, among others, supplying largely electronic loads in the built environment which require much lower voltages and consequently require voltage and current transformation which is done by the ubiquitous AC/DC Power Supply (PSU) which use switching means. The luminaire load disclosed herein represents an HFAC microgrid transforming device interfacing with such as a luminaire load which is not dependent on switching. Such a linear power transformation device obviates 90% of electronic componentry, say, allowing advantages of lower cost and higher reliability, while also providing greater photon production flexibility and EMC complaint photo pulse power.

HFAC power distribution has many precedent varieties and is almost universally applied in the military and aerospace. Naval shipboard power distribution for heavy machine actuators use the MFAC (Medium Frequency AC) frequency of 600 Hz; in civil aviation 600 Hz is also almost universally used for heavy aircraft aileron control while higher frequencies are used in satellites and rocketry culminating perhaps with the International Space Station using the HFAC power distribution frequency of 100 KHz. HFAC usage in military and space suits the greatest demand for reliability and low weight attributes of a technology, but also is advantaged for related ease and economy of voltage and current transformation. The smaller magnetic components for HFAC minimise weight and size of devices and reduce thermal losses by use of exotic ferrite materials. Smaller devices permit smaller packaging and better shielding which improves the Signal To Noise Ratio (SNR) of critical communications links.

Earthbound LFAC power distribution and attendant in-situ infrastructure and matching dedicated loads have historically provided little advantage in LFAC to HFAC “point of use”. transformation but HFAC technology now has a value seen in complementary function to the major power grids as a microgrid in “off grid” domestic, village or suburban power distribution sub-nets which derive energy from solar, wind and other sustainable sources. These microgrids variously take power from grid, solar or battery and the transformation of loads to suite HFAC power distribution has such advantage as to be attractive in terms of its efficiency to run speed control on rotating motor actuators and the gains for efficiency. High among these attractive attributes is the fact that HFAC power distribution for the domestic habitat is non lethal to human contact or touch.

Additional to the present technical opportunities for a new power distribution topology is the lack of clear advantage for any technology to provide the requirements of simultaneously powering and communicating with the burgeoning electronic equipment quantity constituting the Internet of Things (IoT). The interconnected wiring infrastructure for “lighting” is emerging as the “ubiquitous bus” connecting this wide variety of sensors, actuators and communicating devices in the industrial, office and domestic habitat. Such a topology disclosed herein is suited to perform this role as a photon producing load and this power distribution methodology is a proponent for the role of communicating and powering the IoT principally based on its facility for photon production which can serve as a central application for the nucleation of other IoT services.

One specific application of this photon production flexibility is emission of “Temporally Disassembled Spectrum Irradiance” (TDSI) which provides high frequency sequences of high peak photoflux density photo pulses for bio-synthesis and other photo-chemical application. This function is highly programmable and facilitates a wide range of technical advantage in lighting, in horticulture, in communications and other applications. The innovation disclosed herein uniquely relies on an innovative form of parametric regulation intrinsically defined by an electronic circuit topology.

In respect of the generic nature of the innovation herein disclosed, functioning advantageously over a wide range of application, this patent specification discloses a device defined by a unique parametric topology representing a unity of invention. Parametric theory is comprised of two types, these being the degenerate and the non-degenerate type. The embodiment herein is classified as being of the non-degenerate form which depends for advantage on the interaction of three frequencies, the pump frequency, the power dissipation frequency, and the idler frequency. In usual parametric applications such circuitry provides a single benefit such as amplification or timekeeping. The application disclosed herein achieves simultaneous solution of a regulation for power distribution and unity power factor presentation to the pump frequency energy source. This simultaneity of design thus provides proper termination to the HFAC bus by representing a resonant load with optimal power transfer. In the emerging complexities of power distribution of sustainable energy such a network provides distributed power, distributed loads and communication for the simple cohesion of emerging microgrid topology while using minimal components. The significance for communications relies on the transparency of the power transformation described herein to passage of signal carriers by use of ancillary ferrite windings and terminations. The power transformation device disclosed herein can also be understood as a filter, which isolates high frequency perturbations of any load from the power projection of the High Frequency AC bussing. Such a filter operation can be understood remembering every resonant circuit absorbs energy ONLY at the resonance frequency, either from the HFAC bus or in reverse from the load.

In the extreme radiant wattage power requirement of horticulture, the AC/DC transformation is the major cause of failure in the effort to emulate the evolved effectiveness of plant biosynthesis which uses the photo-radiation from the sun. This requires lighting to replace such broadband insolation of 1 KW/m² which is beyond the radiant continuous power projection capacity of LED based luminaires using constant current drive, and specifically the cost of their powering, at the time of writing.

The contemporary concept of “lighting” is derived of historical exploitation of firelight for warmth and illumination and is learned over time to be of an intractable nature. Similarly, from gaslight even to the advent of incandescent lighting and fluorescent lighting, such photon sources could NOT be switched on/off with any rapidity conducive of their reliability, so the spectral components of such lighting were inaccessible at the point of generation for the purpose of high frequency dynamic sequencing or other photonic manipulation. It is perhaps the sociologic imprint of such intractable photo-production that has inhibited the greater expectation that advantage could be had from exploitation of lighting by exposition and management of its constituent spectral components in relation to the manner electromagnetic radiation is used by plants and mammalian life forms. All life forms have evolved dependent on the periodic gross photonic immersion of insolation, either directly or indirectly, and while LED semiconductor junctions are able to generate photons of a wide variety of wavelengths, such irradiance generated is not necessarily best used continuing the practice of constant broadband irradiation with the familiar constancy of insolation. The bio-forms such photonic immersion supports are evidenced to rely on the summation of gross multi-wavelength photon interaction with gross wavelength photosensitive bio-molecular presentation over time, and only in such gross continuous photon stream applied to large populations of photo-sensitive bio-molecular interactions is the photo-dependence seen to be constant and irrespective of spectral components.

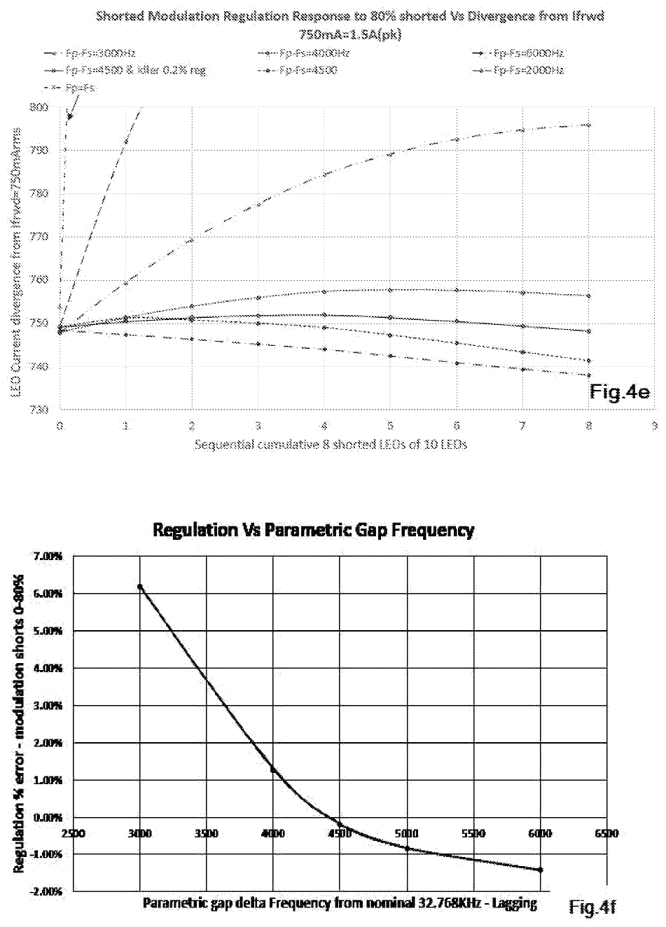

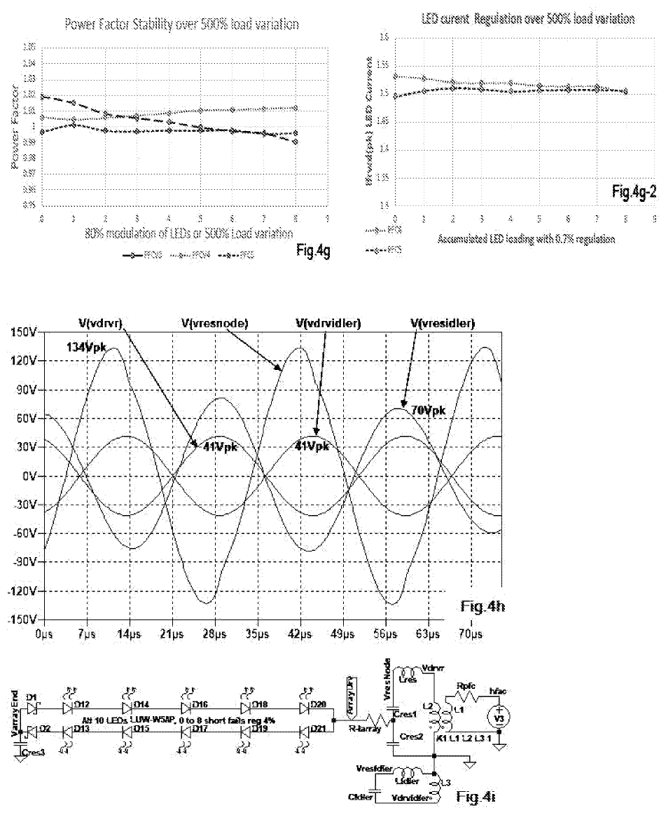

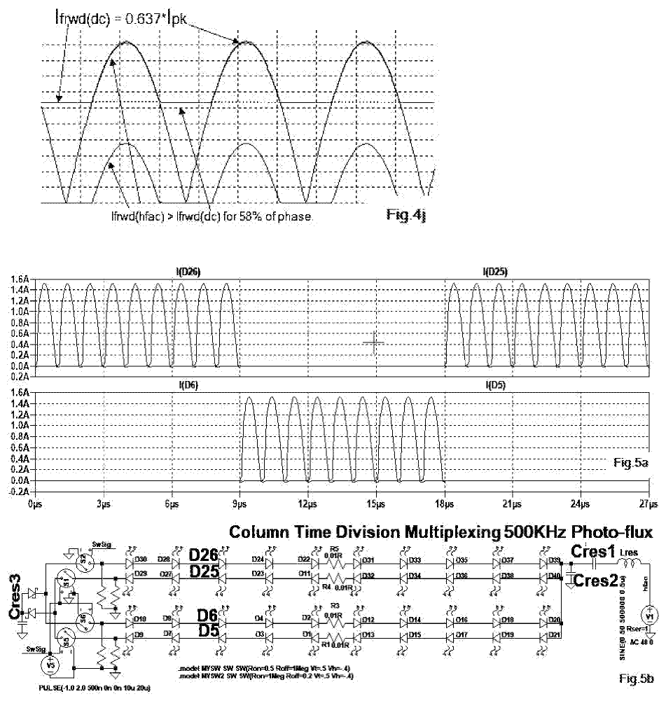

Most forms of synthetic technically manipulable photon production are from diodic junctions of various forms, and such diode junctions produce a photo-flux density proportional to current and consequently the power applied. Such spectral sequencing as may emulate a conventional “light” source depends on an areal distribution of the power to the irradiation elements and these much greater areas of switched charge as may be supplied by the conventional AC/DC Power Supply (PSU) are probable causes of RFI for switched DC signals. This specification uses the rectification function, as normally a part of conventional PSU, to be performed by the LED arrays emitting the radiance. In one manner, the LED array such as may be driven by the subject topology of this innovation is a switched secondary side regulated by parametric interactions in magnetics of resonance by the primary high voltage side and such regulation is effected without switching means such as shown in FIG. 1. Further FIGS. 4a,b,c,d,e,f,g,h,i among other figures attest to the EMC regulatory competence of the subject innovation of power transformation topology specified herein.

The term “parametric” refers to the reliance between circuit parameters exhibiting strategic inter-active compensation to achieve a desired effect such as regulation of output power to a degree independent of power input to such a regulating device. Herein the parametric effect, in concert with the said theory of parametrics, relies on parameter “resonance” and other non-linearities which by design overtly minimise use of switching components for the purpose of power transformation as conventionally performed by AC/DC PSU. Alternately, conventional practice at the time of writing is to “chop” input voltages and attendant current, then pass such high frequency waveforms through a transformer, which are then rectified and filtered. This transformation of power into usable voltages and photon output devices required as herein requires a plethora of components and such high voltage switching is a high energy process with consequent propensity for component failure.

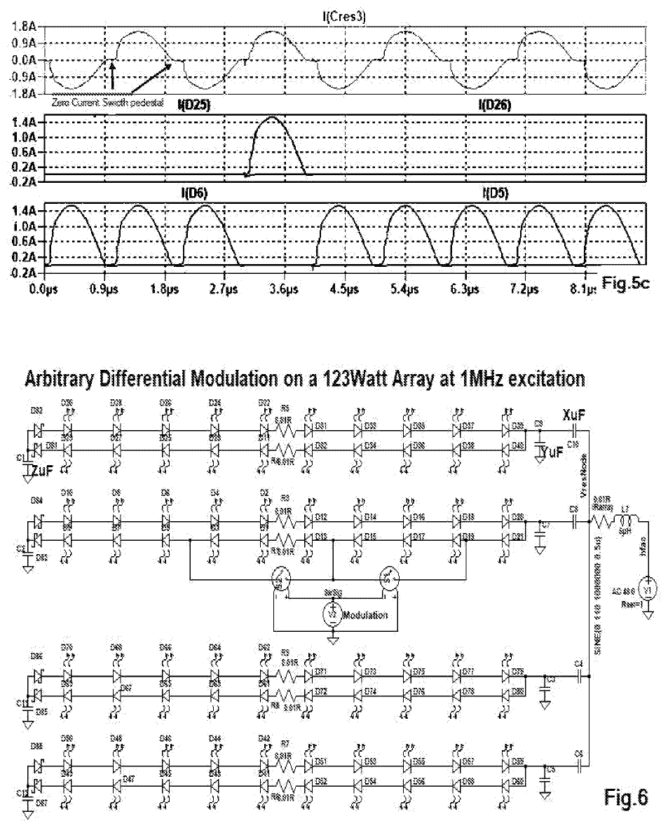

The power transformation means herein specified integrates high power LED devices within the power transformation topology itself, as is depicted in FIG. 1 and specifically FIG. 5b where it can be interpreted that the LED array is across the isolation gap normally existing between the primary side of a conventional switching PSU and the secondary side. Such transmogrification of a conventional AC/DC power transformation topology provides many advantages as specified herein one of which is reduction of the propensity of switched technology to create undesirable Electro Magnetic Frequency noise or otherwise termed Radio Frequency Interference.

Modern LED components provide an opportunity to not only switch the irradiation ON/OFF quickly, but are available in an array of colours or wavelengths at a quantum efficiency far exceeding the efficiency of previous lighting means. This access to specific wavelengths of light allows consideration of powering transient components of a spectrum in sequence with great rapidity, and this in turn attracts attention to the unique requirements of a power supply, or drive method, and its associated topology for the say LED arrays being powered transiently and radiating programmable sequential spectral components at high radiant power.

As a first consideration it is assumed that to produce high photo-flux density that the LED components will be of the type requiring large forward currents. It is noted that the large area of loop currents expected of distributed radiance source lighting by large populations of LED emitters is a hazard for achieving EMC compliance. The power distribution for LED luminaires, say, is a critical design issue proportional in difficulty to the existence of the use of high frequencies when considering areal coverage required for the built environment. Such a topology for transient power projection must adhere to the design strictures of Zero Current Switching and Zero Voltage switching and the projection of sinusoidal whole phases which have optimal low RFI. Large current loop areas must be avoided which do not represent switching transients or take quantities of charge across voltage gradients at high slew rate and generate problematic electromagnetic spectrum disturbance and cause EMC non-compliance.

Such a means of supplying transient power by interactions of whole sinewave phases as disclosed herein benefits naturally by avoiding high frequency DC voltage switching such as overt PWM, Frequency modulation or other switching regulation. The parametric techniques specified herein rely solely to the interaction in resonance of whole sinewave phases to such an extent to be “radio silent”.

The application of HFAC power distribution has beneficial attributes for applications in the bio-sciences. Referring to FIG. 4j it is noted that for the same dissipation the peak current average is 21% higher than the equivalent flux producing DC Ifrwd current, for 58% of the time. The greater Ifrwd(av) equalling Ifrwd(dc) creates disproportionally higher Photosynthetically Active Flux density, thus exceeding the loss of interaction with an actinic site over the periods of nil emission about zero crossings of the haversine photoflux density waveform. Such evidence is found applying the photoflux waveforms herein to Phosphor composed of Cerium and Europium where the latter material is added to extend the decay period. Such testing, in theoretical agreement with particle physics demonstrated a minimum of 14% increase in gross secondary radiation production as measured by two international photonics laboratories. The photoflux waveform generation topology and device described herein is derived of the continued expectation that actinic irradiance of chlorophyll has similar secondary effects for metabolic fixing of CO2 and fluorometry radiation generation as was demonstrated with phosphor nanoparticulates being similarly a product of photon density.

Understanding that single-polarity high current LEDs as shown in say FIG. 1 are used in this example embodiment means TWO LEDs are thus required for full wave rectification to produce a full wave rectified haversine of photon density, with attendant increased expense. However for the purpose of the generation of photoflux intensities herein the larger Ifrwd(pk) driven through the LED arrays provides greater expectation of longer LM80 given the lower thermal dissipation of each of the two LED packages. It is noted that the cost of power is a far greater expense over the service lifetime of a luminaire than the initial capital expense, incurred by LED emitter components, and the power required in the horticulture application is the biggest cost impost. This observation of HFAC LED current drive having a benefit of higher peak excitation photoflux to generate greater secondary emission is further demonstrated in the manner switched LASER excitation of phosphor is used to create disproportionate secondary emission of photoflux.

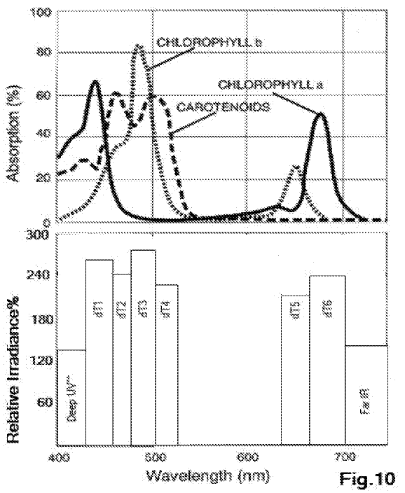

An opening explanation of the principals of operation, of Temporally Disassembled Spectrum Irradiance (TDSI) as related to one embodiment, refer to FIG. 10 which shows the discrete LED spectrum of 8 wavelength emitters approximating the irradiation intensity profile of a LED luminaire optimal to match the photosynthesis absorption spectrum of an example plant. It is noted that most horticulture lighting luminaires of prior art, supply constant irradiation of such wavelengths or colours onto the plants, and it is known that for the photosynthesis reaction (6CO₂+6H₂O→C6H₁₂O₆+6O₂) only ONE photon of the appropriate wavelength, or energy, needs to impact the actinic site on ONE chlorophyll molecule, proximal to another such molecule, for the transfer of ONE electron from the one molecule to the other. This is a probabilistic encounter between a photon of the right energy and an electron of the right orbit at the right distance from a neighboring chlorophyll molecule presented on the thylakoid membrane within the chloroplast of a plant. It is sensical to understand not all wavelengths impact this actinic site simultaneously, and the overall consequence of the gross irradiation is an average outcome dependent on the huge populations of chlorophyll molecules presented to such huge volumes of photons with a wide variety of wavelengths. However, the empirically discerned plant absorption of the wavelengths comprising the Photosynthetically Active Radiation (PAR) spectrum intensity profile, at present guiding the design of hort irradiation luminaires, indicates there is a greater propensity for SOME wavelengths to create the event of photosynthesis, as is shown in the PAR profile example represented in FIG. 10.

In general terms, where Γ is a time interval limited within some time constant of the irradiated process, and Photo Flux Density (PFD) is an emission rate of photon delivery represented by ξᵣ(t):

Γ×ξᵣ(t)=k×W_{rad}

where W_{rad} represents radiant watts, the time based units of power, and k is a conversion constant.

If n₍ₙ₎ is the quantity of photons at wavelength λ₍ₙ₎ delivered in the time period Γ then the Photo Flux density delivery rate ξᵣ can be expressed as:

Σₜ^{Γ}ϵr(t)=n₁*λ₁+n₂*λ₂+n₃*λ₃+ . . . n₍ₙ₎*λ₍ₙ₎

Let emission of photons of the LED emitter current be such that each dΓ expends an incremental radiant Wattage power representing the quantum efficiency:

dW_{rad}=F(n₍ₙ₎, λ₍ₙ₎)

If Γ is the sum of all dΓ terms during which each wavelengths quantity “n” of photons is emitted then at any time dΓ only that wavelength requires power for emission. Over the time integral to Γ the power required is proportional only to the average required for each dΓ, this because power is related to time interval and it is contrived that the sum of incremental dΓ being Γ is related to a persistence of effect or is a temporal window within which changes of photoflux have minimal effect due to some saturation of sensors or limit of sensory detection.

It is noted that most photo-chemistry reactions, and certainly photo-biochemistry reactions, have temporal components involved in photo inducted reactions, which in general are functions of surrounding structures effecting metabolic change or inducements of neurophysiology. In general this is referred to as an Integration Time Constant for the photo-chemical reaction outcome. For examples this is evidenced in mammalian ophthalmology and also in plant photosynthesis.

One example in ophthalmology is the human eye. It is known the perception of the color “white” is dependent on the receptor sensitivity of the eye, in simple terms, to a group of principal spectral components being the wavelengths of Red, Green and Blue. It is also known that the human eye has a persistence evidenced by the phenomenon referred to as Flicker Fusion that does not distinguish flashing of a light above 100 Hz, say, where above 100 Hz the eye perceives constant irradiation whereas the emitted photons composing the perceived white photoflux are in discrete gross photoflux batches of intermixed Red, Green and Blue wavelengths. This phenomenon of Flicker Fusion is considered a form of saturation of the photosensitive molecular receptors of the eye where the reaction time base for response is longer than the interval between flicker events. In the spectral dissection administered by the innovation specified herein, the spectral components of each batch of combined wavelengths are further dissected into their individual spectral components for irradiation at a commensurate power required for the overall equality of photon delivery for Hue and Intensity. The emission control of the subject innovation is able to balance spectral components and perceived “brightness”, but emitted at each sequential wavelength of the original colour or wavelength combination at high scan rate delivered at incremental time intervals much smaller than the overall reaction time constant of the photo-reaction of the human eye.

In this case Γ represents the integration time interval of 1/100=10 mSec within which the composite spectrum can be dissected and presented to the eye as each spectral component of white in succession of time increment dΓ to the total of Γ=10 mSec. This dissection of the spectral components and then irradiation of the eye, at a rate exceeding the reaction time of the eyes sensor systems is referred to herein as the process of Temporally Disassembled Irradiation (TDSI).

The perceived intensity is photon quantity rate of arrival, it is a constant “process” subjected to fiducial points of rates of change related to limits within the photo chemical reactions and surrounding process such as the 10 mSec period above. The photoflux density represents luminance intensity, and the integral over time Γ in this example integrates photon accumulation to “white” energy impacting the human eye fovea.

W_{white}=F(n₍ₙ₎,λ₍ₙ₎)

W_{white}=Σ₀^{Γ}ϵr dΓ=Σₜ^{Γ}(F(n₁(t)*λred+F(n₂(t)*λblue+n₃(t)*λgreen)dt

For simplicity of discussion, assuming the photon density ξᵣ, the photoflux stream for the perception of white is equally proportioned between Red, Green and Blue photon wavelength arrival say,

ζr/3=n₁*λ_{red}=n₂*λ_{blue}=n₃*λ_{green} viz. n₁(t)=n₂(t)=n₃(t) at any instant “t”

It is valid to assume that if the perception of white has perceived persistence, represented by the evidence of “flicker fusion”, so will each of the component spectral wavelengths. This assumption is relied upon only within the period of the 10 mSec flicker fusion fiducial rate of detection indiscrimination. At any interval Γ<10 mSec such perceived intensity for the same photoflux has greater intensity to a limit of the response of the molecular receptors.

Assume, by way of numeric example, a luminous intensity Εᵣ of 900 “white” photons every 9 mSec was impacting the human fovea and the eye was registering constant “white” color. The said 900 “white” photons is thus actually comprised of 900 “red” photons, 900 “Green” photons and 900 “Blue” photons which are interacting with human eye photochemical Red, Green and Blue sensor molecule actinic sites simultaneously, and specifically, in no temporal order.

The immediate observation is that establishing a temporal order such that for 3 mSec all 300 required Red wavelength photons were radiated onto the same fovea, then 3 mSec for all the 300 Blue photons, then the Green photons for 3 mSec then the same total of 3×300=900 photons accumulating to the reaction as “white” will have impacted the eyeball and will register “white”. It is emphasized that such an emulation of a constant time domain delivery by sequential delivery of same photon quanta frequency domain components is performed within the response time constant of the eye sensors. Within this longer bio-reaction time constant, such as the 10 mSec persistence limit, the eye cannot register changes sufficient to detect ordered temporal reception.

The immediate benefit is noted to be only 33% of power the original 900 photon “white” photon stream requires is needed. If as assumed equal Red, Blue, and Green photons are needed in the 9 mSec interval, only 33% of the power is being expended every 3 mSeconds as each successive wavelength of the three, being Red, Blue and Green is radiated. The average power required for emission is say 30% of that required for the original “white” photon stream.

This is the first wavelength dissection for the application of “white” vision which will change its photon wavelength balance as other “colours” are perceived. However intensity even of primary colours should consistently remain within the photon production limits established for intense “white”.

It is immediately obvious in view of the operating frequency of the innovation specified herein that further temporal dissection of composite wavelengths is possible. If every 3 mSec a further 1 mSec temporal allocation to each wavelength was programmed then the power required is reduced ( 1/9) of the original Photon Intensity, then being 100 photons each of Red, Blue and Green received every 1 millisecond retransmitted three times for each three wavelength component scan over the response time constant, still summing to the 10 mSec interval total arrival of 900 photons, and therefore still registering the same intensity at the eye—provided the reception rate efficiency of the photo-sensitive molecules reacting to the shorter bolus of photoflux remains adequate to maintain the reaction.

Further explanation consistent with the increased secondary radiation from phosphor reported above relates to the decay time constant of the receptors to such temporally separate wavelength intensities. Successive reinforcements of the reception decay are subject to the higher Photoflux densities of the peak wavelength phases of the sinusoidal photoflux density waveform, and are thus more efficient per unit time, this being for the same average LED dissipation. In this fact, proven by the Phosphor nanoparticles increasing of secondary radiation, the additional benefit of power reduction for photo-chemical effect is found. Given the controllability of the innovation specified herein, the irradiation by RGB wavelengths can also be emitted by pairs such that each 9 mSec scans of sequence Red+Green, Green+Blue, Blue+Red can be radiated according to the combinatorial laws depicted in FIG. 9b whereupon the power required for this manner “white” is created is reduced by 33% but may still represent advantage for HUE creation among other benefits such as detection of fluorescence for other diagnostic purposes. This practice allows overlapping scans which leave spectral space void to accommodate variable photo-sensor apparatus response times which are variable, such as in the chloroplast of a plant.

The seeking of further temporal wavelength dissection of a gross radiance effecting a chemical or biological photoflux is not limited to seeking benefit of power reduction, but to reduce the number of LED photon emitter components needed to provide such photo flux. The natural limit of spectral dissection being the frequency response of the mammalian fovea or plant chloroplast or other photo chemistry receptors. As the photon pulses of the composite frequencies is reduced in duty cycles, the bio-molecular response cannot provide adequate response, and the intensity perception is reduced.

This phenomenon of human eye sensitivity response to rates of photon variation is not novel. In 145 AD the Roman philosopher Ptolemy noted this time constant effect while observing spinning tops and the color changes consequent of varying rotation speed of the top. In this age, this phenomenon is related to the term Flicker Fusion. To provide the radiant power required for habitat space illumination or for horticulture the frequency response and radiant power of LEDs is required, and consequently a suitable means of being driven at the power and frequency is required with requisite control.

The fovea of the mammalian eye is only one kind of receptor evolved to an organization for spectral content sensing of electromagnetic wave energy. Plants also exploit irradiated energy for a different purpose, this being to fix CO₂ and accumulate mass according to the structure determined by the replication process encoded in the plants DNA, and the flicker response is restricted to a different degree across the range of species.

It is known that other reaction time constants Γ, consequent of plant evolution have reaction time constants as short as 150 uSec or perhaps shorter, wherein a spectral line strobe of 1.5 uSec at ×100 intensity radiation is shown to have the same umol/cm2/sec growth creation as constant irradiation at the lower intensity of 1% of the same wavelength for the total period of 150 uSec. Such time bases are within the functional performance range of the innovation herein specified and as shown in FIG. 5a, FIG. 5b and FIG. 6. Such functional competences of the innovation specified herein at these frequencies have been applied to actinic sites of phosphors intending on that occasion to elicit secondary radiation with considerable success. On that occasion the time constant Γ was contrived by the addition of longer decay periods to the irradiated phosphor.

The evidence of a time constant to prosecute the photo-chemical reaction of photosynthesis and the preference for specific wavelengths above suggest the PAR profile as shown in FIG. 10 to also be a probability density function representation. The plant, in a manner similar to the human eye has a sensitivity profile and a limitation of photo-sensitive response period here shown by way of examples published and known in the industry for specific plants, to be say, 150 uSec.

It is noted that the 1.5 uSec spectral strobe at ×100 intensity for 1% of the time Γ of 150 uSec has problematic intensity for LED photon production to provide industrial strength photo-irradiation approaching the natural insolation rate ca. 2000 umol/cm²/sec for a bright sunlit day or 500 umol/cm²/sec for a cloudy day.

The subject disclosure is capable of emitting high radiant power spectral line wavelengths into the bio-chemistry mechanism of a plant at commensurate duty cycles, as shown in FIG. 5c derived of the circuitry of FIG. 5b, and allowing 12 scan periods within the 150 uSec time constant scanning period to radiate the 8 wavelengths shown in FIG. 10. This is executed according to the simple arithmetic as above example achieving reduction of power required to register hue in the human eye. The plant fixes carbon by using photo-flux, the mammal induces a neurological response component for the neurology of sight at a much longer reaction time.

The processing performed by the preferred embodiment determines that each of the eight wavelengths of FIG. 10 are radiated sequentially at 1.5 uSec per wavelength in contiguous sequence. It is noted the human eye cannot perceive such short photon pulses but the simpler photon capture means of a plant have been evidenced to be receptive to this form of photon strobing wherein it is determined by experts in the field that plant chloroplasts can “capture” photons.

Each scan over all 8 wavelengths thus takes 8×1.5=12 uSec, and there are thus 12 scan sequences possible within this persistence of susceptibility Γ period of 150 uSec. Given the probability density profile of the PAR profile each wavelength has probability of effecting photosynthesis proportional to the amplitude on the PAR profile and 12 sequential scans reduces the intensity needed by that wavelength output by that proportion which was a high intensity at 1% of the period of 150 uSec. So the intensity for the one wavelength of say 680 nm is then 1/12 of the original required wavelength intensity to deliver the same photons and it provides these photons in 12 scans within the Γ of 150 uSec.

There is also a disproportionate advantage in including all the 8 wavelengths in the same scanning strategy which is different for each plant species and assuming the radiation of 1 wavelength at ×100 intensity at 1% duty cycle provides the same growth as 1% intensity over the total period Γ then the multiple wavelengths also reduces the intensity overall by a factor of ⅛ which makes the power reduction factor 1/12×⅛= 1/96 which places the TDSI method as a proponent for insolation emulation to some degree for all plant species. In this wavelength dissection process the natural limit is not the high frequency radiant competence of the subject innovation, but the ability of the mammalian eye and the plant chloroplast molecular structures to react to lower intensity shorter duration photon bursts. For the creation of “white” in the human visual senses, lower intensity shorter photon bursts converge exponentially in overall effect to lower intensity “white” perception at greater degrees of spectral dissection.

It is also the converse that greater benefit is to be gained for power reduction with wider spectral requirements at longer “persistence” or reaction time constants.

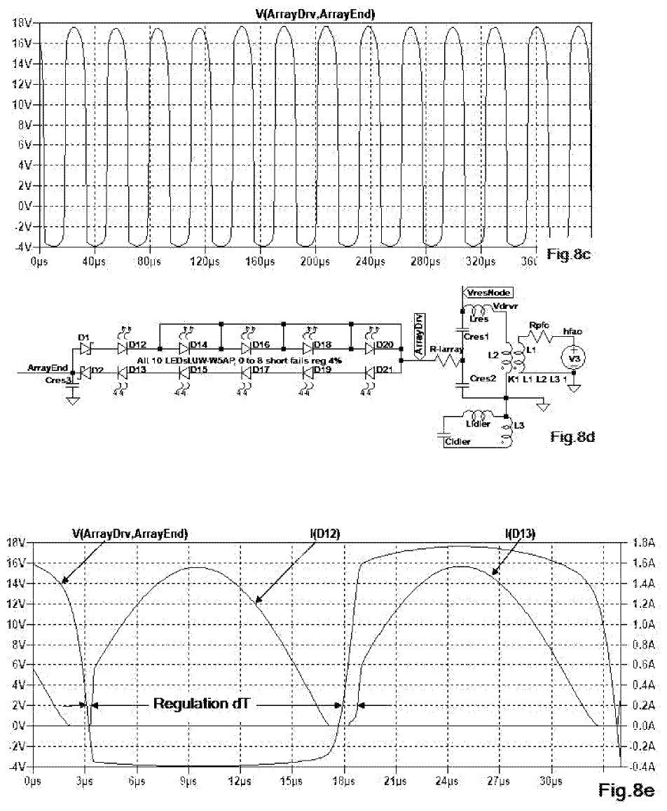

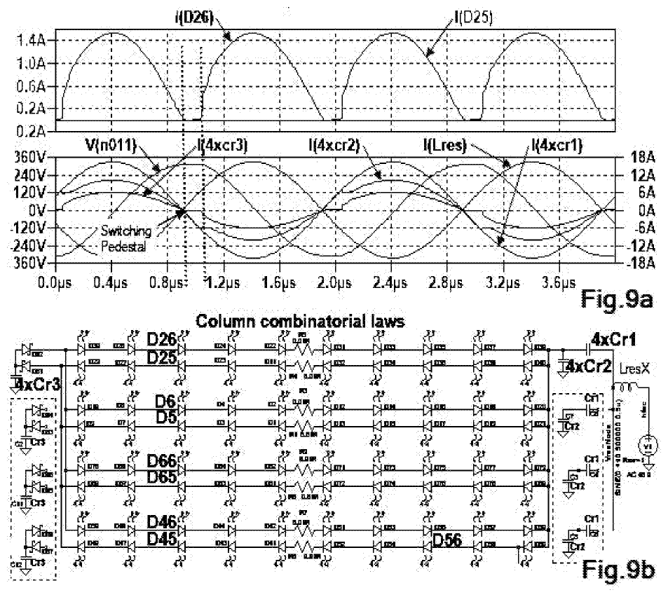

The subject parametric powered LED array shown in FIG. 9b has column collation arithmetic as compared to FIG. 6 where capacitances XuF, YuF and ZuF from FIG. 6 are summed in FIG. 9b allowing conversion between columns intended to be switched in the manner shown in FIG. 5b. The switching happens in the convenient intervals shown in FIG. 3 of single wavelength columns. It is noted in FIG. 8a that such column collations have integrity in regard different Vfrwdby the quantity of short failures of FIG. 8a which remain regulated. It is noted that for various reasons a null radiance is needed, this is achieved by the inclusion of a strategic non-radiant uni-polar diode pair column or polarity restricted half column pair which retains the ability of the energized system to continue inductance field energy and capacitor electric charge resonant transfers without catastrophic discontinuity.

The regulation of different Vfrwd LED components related to different LED colors have column Vfrwd ignition voltage points each cycle of the driving sinewaves is dependent on the AC coupling of Cres1, Cres2, Cres3. This accounts largely for the modulation extent shown in FIG. 8a. But when switched at zero current pedestals shown on FIG. 9a, there is continued and smooth regulation.

In this specification it is taken that failure resilience is equivalent to modulation when considering a failed LED being “off” represents 100% modulation depth. This insensitivity to element change of conduction also influences the reliability of communication and it is an attribute of this innovation that such failure resilience also has beneficial consequence for the communications function allowing emitter and receiver sets of component elements to be reselected upon detection of impairment.

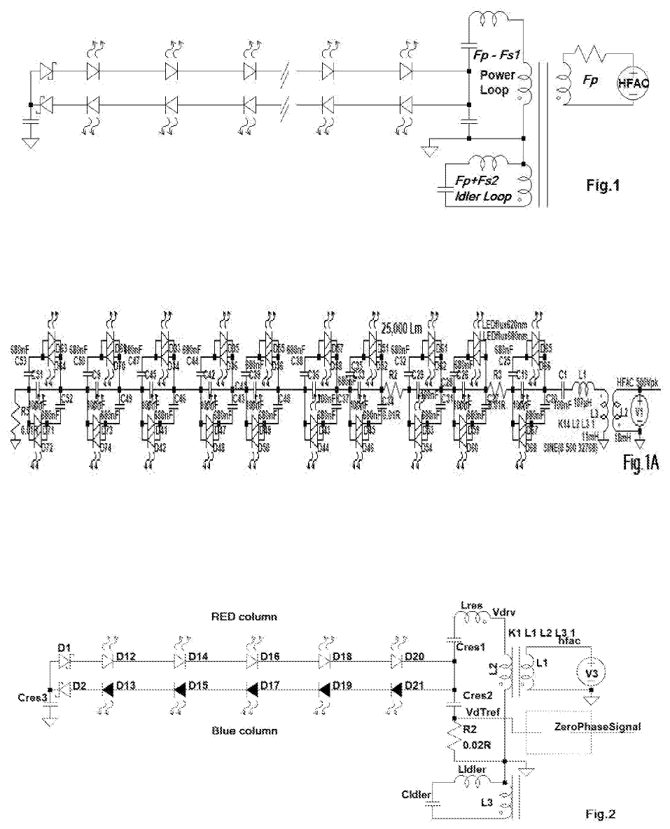

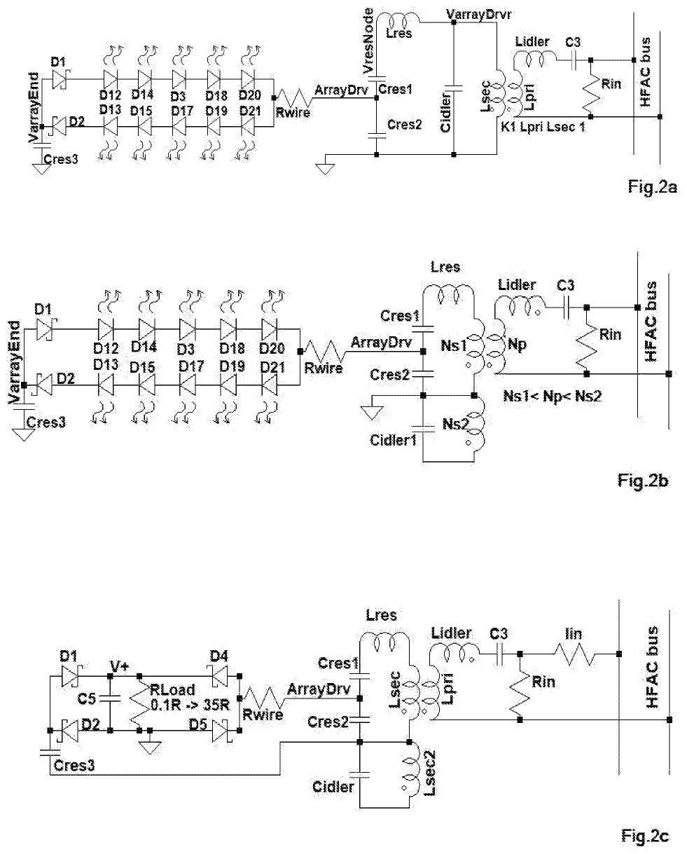

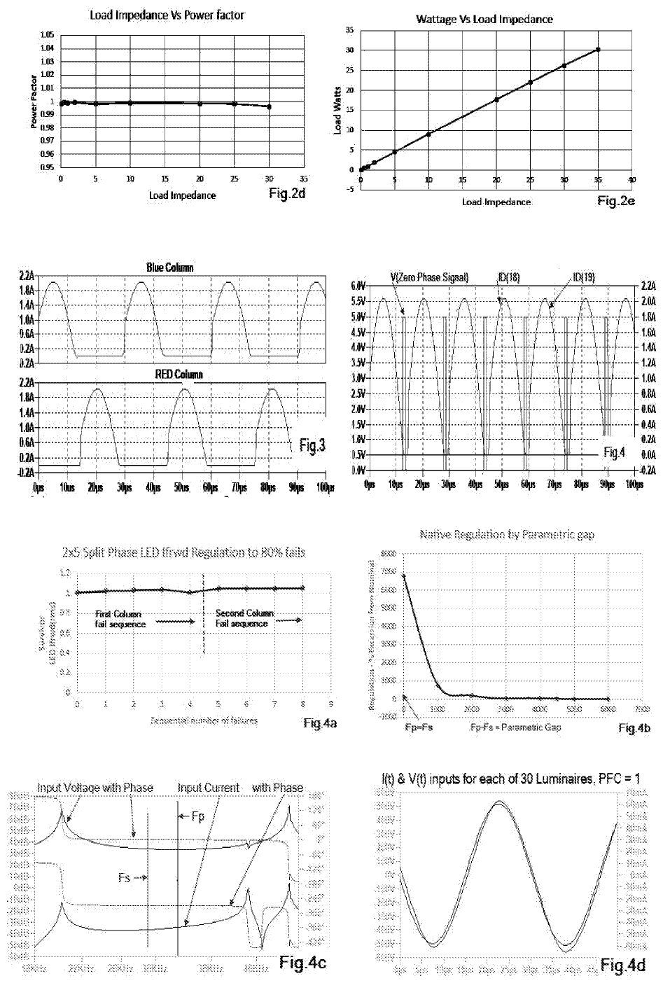

While this disclosure uses the non-linearities of LEDs to demonstrate regulation, the essential non-linearity for parametric effect is also provided by commonplace full wave rectification as shown in FIG. 2c with performance details shown in FIG. 2d and FIG. 2e. response of the failure resilience is commensurate with the requirements of communications modulation. Such applications suited to this minimal power transformation from the convenience of HFAC power projection are the conventional DC driven rotating motors operating within the designed power limits for power demand. However AC motors are the most economical for such service as may be required for horticulture where the switching of phases implied by FIG. 5b can create bi-polar phases of magnetic loops for such as PCB motors or stepping motors

### Definitions

LIGHT EMITTING DIODE used herein as a grammatical noun, refers to a diode which emits illumination or other photonic radiation when current is passed through it from Anode to cathode. There are many LED types and other light emitting devices suited to this drive technology such as LASER LEDs and VCSEL types. Other elements such as OLEDs are also suited. Any light emitting “island” or discrete area device requiring power and organised for the passage of current across a diodic effect may be suited to the subject drive technology specified herein.

PARAMETRIC as used herein is derived of the classic treatments of interacting resonant frequencies applied to non-linearities to create a single function such as signal amplification or critical timekeeping and are considered “closed” systems. Parametric theory is comprised of two types, these being the degenerate and the non-degenerate type. The embodiment herein is classified as being of the non-degenerate form which depends for advantage on the interaction of three frequencies, the pump frequency, the power dissipation frequency, and the idler frequency. In usual application such circuitry provides a single benefit such as amplification or timekeeping, in this application for power distribution the simultaneous consequence of power regulation and unity power factor presentation to the pump frequency are achieved. This simultaneity of design thus provides proper termination to the HFAC bus by representing a resonant load with consequent optimal power transfer. This disclosure may represent an example of an “unconstrained parametric array”, and as such the network, in which this disclosure is a “load”, is theoretically extensible to infinity by retaining these parametric attributes. In the emerging complexities of power distribution of sustainable energy such a network provides distributed power, distributed loads and communication for the simple cohesion of emerging microgrid topology while using minimal components. The significance for communications relies on the transparency of the power transformation described herein to passage of signal carriers by use of ancillary ferrite windings and terminations. The subject innovation is highly transparent to Phase Shift modulation (PSK). The power transformation device disclosed herein can also be understood as a filter, which insulates high frequency perturbations of any load from the power projection of the High Frequency AC bussing. Such a filter operation can be understood remembering every resonant circuit absorbs energy ONLY at the resonance frequency, either from the HFAC bus or in reverse from the load.

TOPOLOGY as used herein as a grammatical noun refers to a physical shape and interconnectedness of circuit functions which have interactions described by a single mathematical transfer function. Such a term as “topology” infers a spatial relationship essential to the nature of this innovation. Parametric systems of low noise amplification and time keeping are “closed” systems, meaning they are volumetrically contained. This innovation herein disclosed is an example of an “unconstrained parametric array” meaning such regulated or autonomously controlled effect is extensible by theoretically endless replication of such a topological assembly attached to the same replication of power source means for power projection.

PSU as used herein as an acronym, refers to “Power Supply Unit” and such context as “AC/DC” PSU means a power supply unit that converts an AC voltage and AC current to one or more DC voltages and currents. In wider reference a PSU that converts AC voltages and currents to AC voltages and currents at different frequencies is termed a cycloconverter.

EMC is an acronym as used herein means Electro Magnetic Compliance. There are various regulatory restrictions on the by-product of switching currents and voltages which causes Radio Frequency Interference and pollutes the electromagnetic spectrum which is used for such services as WIFI and other radio and TV services. Such standards are CISPR11 thru CISPR31, IEC6100 series and many more in various jurisdictions.

PLC as used herein is an acronym referring to Power Line Communications. This is a well established technology with a number of high profile vendors for chipsets and end product modems. It is a means of inserting High Frequency multi-megahertz waveforms on the established and in situ 50/60 Hz lighting wiring or power cabling of the built environment. The physical layer runs by amplitude modulation of a baseband set of close packed frequencies at orthogonal wavelength separations and this modulation method is termed Orthogonal Frequency Domain Modulation which is familiar to the entire WiFi domain. The parametric power distribution network disclosed herein is an ideal signal distribution hardware layer for this signal propagation due to the high impedance of the entire network to all signals not at the power absorbance frequency of 32.768 KHz. This high impedance to say 60 dB baseband frequency separation to the power absorbance at 32 KHz allows ideally low insertion loss and consequently high Signal to Noise ratio which converts to high bitrates of Giga Hertz transmission throughput.

MTTF is an acronym referring to the Mean Time To Failure which is an estimate of the average time before a failure might occur of a device. This quantity can be understood in units of time being hours, days, weeks or years. It is understood the statistical method to determine an MTTF is to assess the probability distributions for failures of all the component parts of said device, and this assessment includes the degree of covariance between components such that the predisposing of one component failure influences successive and related components to fail. Such an example of high covariance is a single DC driven LED string where the failure of ONE LED going open circuit extinguishes the entire column and this represents 100% covariance. In a two column DC LED array of say 10 LEDs, an open circuit OR a Short circuit causes 100% redistribution of the Constant current PSU through the ONE column initiating the DC driven “failure Cascade” which is a major product liability especially for high power lighting.

VLC used herein as an acronym refers to Visual Light Communication where the intensity or composite spectral wavelengths of light are modulated to define a telecommunications signal. The wavelengths of VLC are shorter and the related high frequency has much greater information capacity per unit time than conventional Electromagnetic wavelengths of the radio spectrum.

RGB as used herein is an acronym which refers to the primary colours, and the wavelengths, of “white” being Red, Blue and Green.

NPO and MLC as used herein are acronyms which refer to capacitor components where NPO refers to “No Positive 0” (zero) change in capacitance over temperature variation and MLC refers to Multi Layer Capacitor, which are much smaller than foil capacitors for the same capacitance and voltage specification.

ARRAY as used herein as a grammatical noun refers to spatial arrangements of pluralities of connected elements having any dimension and plurality of such as LED components. An X-Y array means X LEDs in Y columns for example.

REGULATED as used herein refers to control of a particular electrical parameter such as voltage, current or power. It does NOT intend any degree of such regulation except to imply the parameter is not destructive to the device or system and performs in a predictable manner and to a lesser degree than other parameters in some relation with it. The degree of regulation depends on explicit context.

LINK CONVERTER as used herein is a term related to a digital power transforming device which creates sub-frequencies by division of the HFAC frequency power pulses, and such subharmonics are directed equably as say three phase, or multiple phases to drive electric motors or other mechanical actuators. Such motors have advantage of greater torque associated with speed control for such as air-conditioning compressor motors, fans or pumps such as are employed in horticulture and elsewhere industrial. The switching freedoms of the power waveforms of the subject innovation provides an advantageous means of projecting energy.

TDSI is an acronym used herein which expands to “Temporally Disassembled Spectrum Irradiation” which defines the functionality of the innovation herein in the embodiment of the subject topology. The disclosed advantage of this technique is in reducing the electrical power needed for say, horticulture irradiance by LEDs or other photoemitters while providing intensities at spectral line-widths unable to be supplied by straight DC constant current switching. The inability of DC switching to provide such intense spectral linewidths is due to the response times of the constant current overt control systems employed for conventional constant current or constant voltage systems. It is shown herein that this innovation can switch multiple columns of a single wavelength, or a combination of wavelength columns of very high intensity from an instant of zero LED current at MHz rates of scanning. It is shown that an initial broadband irradiance which is determined to be required for a photochemical effect within a known reaction time can be replaced by a high frequency scanning of the composite wavelengths of the original broadband photoflux within the same time constant for the reaction.

PERSISTENCE as used herein as a grammatical noun the term “persistence” is widely intended to mean a material and measurable effect which has time dependent attributes following the impact of photonic exposure. In general usage the term “persistence” imparts an effect visually observable after the impact of a photonic irradiation such as decaying secondary radiation. In the frequency domain wherein much of the subject specification has consequence, such “persistence” term is intended to extend to the post irradiation neurological and/or metabolic consequences of such an impact of irradiation which is not visually observable.

Persistence is also used herein to loosely relate to the reaction time constants inferred in the use of TDSI above. In other usage the term persistence can relate to the phenomenon of “phosphorescence” of materials both with decay of secondary radiation and others without significant decay time constants. Some secondary radiation is produced by materials almost simultaneous with irradiation and others of complexity where some wavelengths produce secondary radiation at other wavelengths simultaneously. and others with delayed effect such as certain wavelength relationships at dark/light boundaries and others at light/dark transitions as known to happen in controlled irradiation of the chloroplasts of plants. One such well known creation of secondary radiation is the application of 450 nm Blue LED radiation to Cerium based phosphors which creates gross secondary radiation over the CIE photonic bandwidth by the “stokes shift” creating the human perception of “white”. Such spectral sequential excitation as herein described may be employed to achieve the secondary radiation emission from a composite phosphor minimising the Wattage required for radiated or perceived intensity.

FLUOROMETRY as used herein means a secondary radiation consequent of an irradiation on a plant or other substance and the interpretation of the spectral content of such secondary radiation. Such fluorometry is considered herein to also be consequent of a persistence effect involving in some manner an emission of secondary radiation or a molecular photo-chemical alteration such as a metabolic function in a plant or polymer or an inducement of mammalian neurology.

SNR is an acronym as used herein means Signal Noise Ratio, and is an expression indicating the signal level ratio to the noise level in a communication channel which measures discrimination of the signal content of a transmission.

PAR as an acronym used herein means Photosynthetic Active Radiation and refers to that part of the photonic spectrum used by plants for photosynthesis. It is a wider spectrum than the CIE spectrum used by human eyesight.

PFD and PPFD as used herein are acronyms expanding to mean Photo Flux Density and Photosynthetic Photo Flux Density respectively. PFD is used in general discussion related to photoflux density waveforms which can be DC or can be a haversine as driven by an HFAC sourced current as in the innovation disclosed herein. PPFD however specifically relates to the PAR spectrum, and is that spectrum part intensity generally suited to the plants photosynthesis activities.

### Prior Art

Prior art research shows few predecessor designs exploiting parametric principals not reliant for their regulation on switching technology to provide say, 5 Amp LED drive current regulation at 500 KHz and provide failure resilience where survivor LED elements retain regulation to the extent manufacturers warranty is not violated for extended periods in the furthest outlier MTTF region of the statistical Weibul Distribution. For a large LED population this equates to extending the serviceability of a lighting array albeit of decreasing luminosity by well over a factor of 10. Such a manner of increasing serviceability is more suited to the critical role of “lighting”, especially in public areas and other critical service applications where failure of illumination is not suddenly ceased but is more of a linear degradation. Such critical service functionality is known as “no single point of failure” and befits the service of the innovation specification herein, being natively a redundant design. Some topologies in the patent literature as below have some limited features common with the subject innovation as next.

A common feature related in the prior art of resonant LED drive technology is such as portrayed in U.S. Pat. No. 8,237,374 B2 where it is shown a resonant series circuit driving a bridge rectifier. In contrast the innovation specified herein does not use PWM voltage control by a “controller” (8) and does NOT full wave rectify the output of a resonant circuit, as shown in FIG. 1 herein, but in the application of lighting, half wave rectifies the output of a resonant circuit which has four resonant components as distinct to the referred citations simpler resonance between L1 and C1. The subject innovation herein accomplishes regulation by parametric effects and obviates the regulation function of inverter control circuit shown FIG. 1. The array switching of the unidirectional DC current, shown FIG. 4 of prior art, is not for the ostensible purpose of communication signalling and it would be unlikely to have the frequency response available from the constant current regulating function of the inverter which would have a limited control bandwidth. In the innovation subject of the specification herein the column current regulation is by the parametric response of the energy of resonance, whereas the cited prior art response is filtered heavily by capacitor C2 intended to reduce current ripple over the load array but also presents high insertion loss for signalling. Both the purpose of intra-array switching and the manner of regulation are distinctly different to the innovation specified herein, where casual concern for power factor correction is assumed to be the requisite attribute of the controller means.

Of slightly different topology U.S. Pat. No. 9,622,300 B2 patent defines a resonant drive reliant on a similar disposition of capacitors 318,328 and this topology does not rectify the drive current to the LED columns which are driven by an AC voltage. There is no part of this specification relating auto-regulation of these LED columns, and there is no complex impedance such as shown in the subject innovation specification herein with three capacitances Cres1, Cres2, Cres3 as shown in FIG. 1 of the figures attached.

One design suggesting failure resilience is WO2013/102183 A1 wherein at least there is minimal switching for a network and a degree of failure resilience afforded by a multiplicity of intra-array reactive capacitor components. The subject innovation herein does not have capacitors interspersed with the LED elements of an array. Such an array has failure resilience to both element SHORTS and OPEN failures while having a topology affording regulation of current. In view of the subject specification for high radiant wattage lighting in multiplicity over extensive network deployment there are serious limitations for the industrial application of this prior art specification. One such example application is in the field of horticulture where the advantage as disclosed herein requires say 1 KW horticulture luminaires composed of LEDs requiring 3 Apk and excited by 500 KHz HFAC drive frequencies applied to emulate insolation.

The first limitation being that for high forward current of LEDs where the multiplicity of such capacitance components with the required ripple current rating at reasonable cost require each a physical volume exceeding practicality for a reasonable density of LED emitter elements. This complexity of capacitance components is shown in FIG. 1A. Such capacitors as 680 nF suited to drive 3 Apk at say 500 KHz ripple are large volume components.

A second limitation is that the cost of such high ripple current capacitors of appropriately sized and reliable NPO MLC capacitors in such multiplicity exceeds the cost of the LED emitters and becomes a commercial liability.

A third limitation is the required voltage to drive such arrays as prescribed in the referenced patent WO2013/102183 A1 becomes excessive when accommodating appropriately expensive and reliable capacitors of reduced capacitance at the frequencies appropriate for the subject drive frequencies providing high current, for example 500 KHz or 1 Mhz requires unique capacitance dissipation and for 32 KHz it requires 14 Vrms per capacitance to pass 2 Arms which in a series string such as implied in FIG. 1A would require over 200 Vrms approximately to drive the array shown. For appropriate power capacitors the voltage excess required to drive the capacitors in such a string using 100 nF capacitors at 32 KHz the required voltage is in the region of 1 KV. As required for the innovation herein, the capacitances for Cres1, Cres2 and Cres3 are commonly used large foil capacitors intended for such resonant application allowing the reliability of the subject specification herein and enclosed within the magnetics compartment allowing compact minimal loop current routing for low EMC of the specified LED array.

A fourth limitation of the cited prior art patent, and the most significant limitation, is the negligent non-reference to the uncompensated lagging power factor. In such networked high power and large populations of luminaires it is impractical to accumulate continual addition of lagging power factor loads. Such practice precipitates instability and such indications of pending failure and loss of efficiency is indicated by harmonic distortion of the power distribution bus and difficulty of voltage regulation. Such phase loss between drive voltage and driven current also ensures difficulty to employ distributed power addition to the network, and obviates the efficiency advantage such luminaire loads take from their proximity to resonance to operate with optimal efficiency power transfer from HFAC bussing to photon output. Without compensation for power factor at individual loads among the many other loads of a network, depending on the common power supply quality in such a passive network, the universal efficiency of the network is compromised.

The network attribute for this parametric power distribution method requires each load to encompasses its own traverse of power factor in response to the dynamics of its power consumption. Such functionality is afforded by reliance on the non-degenerate parametric effect in an unconstrained array as is disclosed in this specification shown as FIGS. 1, 2 and for lesser power FIG. 2a. The notable inclusion of auto power factor regulation is a product of the subject disclosure being non-degenerate in parametric form and the referred citation of prior art being of degenerate form. This being evidenced in that the reference citation of prior art is operable with only TWO interacting resonant frequencies of Fs, the power frequency, and Fp the pump frequency. Whereas the subject specification disclosure has a third frequency of the idler loop, where F_{idler} is NOT equal to the Fₚ pump frequency this being the distinguishing characteristic of the parametric theory applied to loads consuming significant power.

A fifth and major limitation is the requirement of the subject citation to use AC LEDs or two LEDs in swapped or contra polarity connection per every TWO high power capacitors. The subject specification alternately uses commonly available LEDs in two entire strings connected in overall opposite polarity as shown in the basic form depicted in FIG. 1. The subject specification allows employment of high power COB LED arrays at whatever power and Ifrwd. While the subject array drive is seen to provide only 31.8% of the photons compared to DC driven LED, by virtue of the half wave rectified current form where Idc(continuous) is equal to Iac(peak), it is the innovation of this specification to provide short pulses of high intensity and this can be switched by wavelength performed on the uni-directional arrays shown in FIG. 2 and functionally shown in FIGS. 5a,b.

A sixth limitation of the related citation of prior art is the degree of modulation depth for any one wavelength as may be deployed in a single unidirectional column. the predominant failure mode within such modulation extent as shown in FIG. 6 has failure resilience to SHORT circuit failures of the LED elements. It is accepted that the predominant failure mode of high current, high power LEDs is that they fail SHORT in 80% of instances. The subject specification retains a minimum current regulation of approximately 2% current regulation in multiple column arrays to 80% of failed elements even in a small 5 LED per column array as shown in FIG. 2. This degree of sustainment of irradiation or manipulation of large percentages of overall modulation of wavelength intensity is not possible in the cited prior art.

This regulation of survivor elements after other LED element failures avoids a failure cascade sequence consequent of current redistribution. In this manner the service lifetime of a luminaire is greatly extended and dependent on the manner of biasing allowed in the design as shown in FIGS. 8c,d. The array can regulate for constant luminosity or constant LED current among survivor LED elements. This avoidance of current re-distribution consequent of LED failure is a characteristic exceeding the competence of the contemporary mode of LED powering by DC drive and is depicted in the graph of FIG. 4a showing survivor LED current across the succession of failures, first of ONE column, then sequential simulated SHORT failures across the second column. It is emphasised DC current redistribution would double the current in the survivor column if one of two columns were shorted. Catastrophic failure is avoided in parametric regulated arrays as shown in FIG. 6 and better in FIG. 8a and FIG. 8b, even in the case of ONE LED remaining within current regulation specification of TWO columns as shown in FIG. 8d with the consequent columns remaining regulated by the parametric effects of FIG. 8c functioning to retain regulation as shown in FIG. 4a and further depicted in FIG. 4e and FIG. 4f.

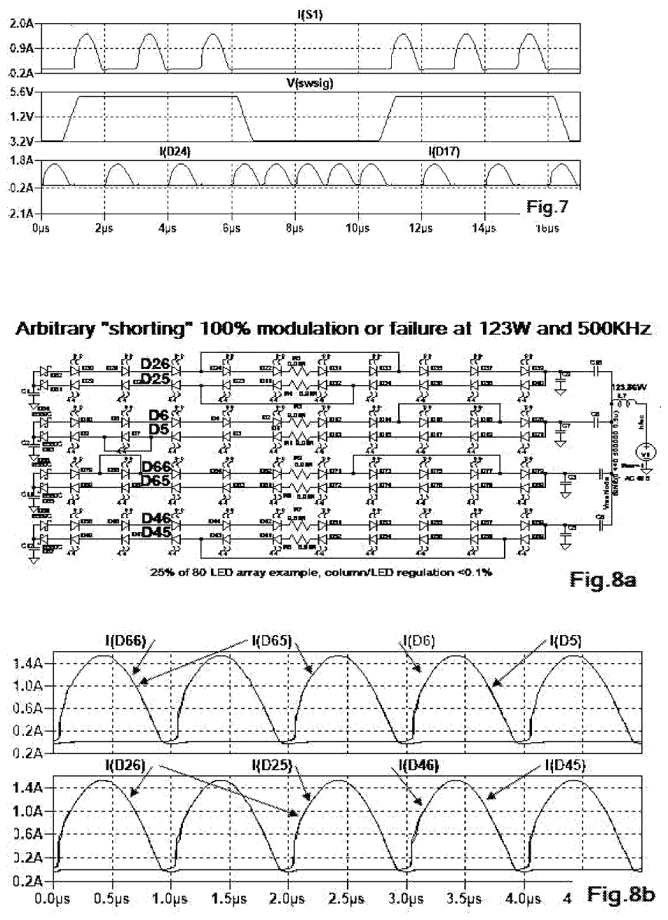

It is noted that the greater sustainment of regulation after the extent of 25% SHORT failures shown in FIG. 8a and FIG. 8b of the subject innovation specified herein is not considered as an attribute for reliability alone either within the communications signal group or within a conventional lighting application for this device innovation. Such failure simulation emulates 100% differential signal modulation as shown in FIG. 6 and the resultant waveforms shown FIG. 7.

There are two means of signalling in the subject innovation herein. The shorting of LEDs as shown in FIG. 6 and FIG. 8a,b and the manner of column switching shown FIG. 5b. Such computer selected switching of columns and associated wavelengths to be radiated allows signalling in wavelengths not being radiated for illumination so benefitting from a contrived high signal to noise ratio in concert with said various modulation options.

A fifth and major innovation specified herein and beyond the scope of the cited patent WO2013/102183 A1 is that the topology therein described provides no opportunity for multiplexing columns nor is claimed to do so in contrast to the subject innovation specified herein and does not rely on a capacitor balance between Cres2 and Cres3 rates of charge accumulation in accord with Cres1 damping accommodation for regulation of current in multiple columns of LEDs as shown in FIG. 9b.

### DETAILED DESCRIPTION OF INVENTION AND RESPECTIVE DRAWINGS

The drawings attached to this specification represent the functions of some preferred embodiments of the topology of the subject device innovation. Considerable explanatory detail is provided hereunder for each drawing representing the scope of the innovation for:
1. General lighting.
2. A device for wavelength scanning photon production at high power and high frequency with complementary facilitation of Visual Light communications.
3. General purpose unity power factor load for an extensible HFAC power distribution Bus.

The operating frequency, termed the pump frequency Fp, driven by the HFAC network from which the luminaires of this innovation specified herein derive power is chosen arbitrarily. However, such a choice of central power distribution frequency determines the settings of resonance, the size of components and other critical settings of the power transformation. The conventional DC driven lighting replacement applications are suited to 32.768 KHz HFAC where the impedance can be specified as appearing with a unity power factor as seen by the HFAC bus and the frequency is usefully divisible by the unsigned binary digit 2¹⁵. This frequency HFAC bus incurs skin effect loss and I²R loss and is arbitrarily specified to project 5 KW at 500 Vpk over 50 m with a voltage loss of <2%. These specifications are arbitrary for the purpose of standardizing components and magnetics construction.

FIG. 1 shows the basic form of the parametric regulated luminaire subject of this specification. The three frequencies defining a non-degenerate parametric system are shown in the current loops as Fp for the energy source pump frequency, Fs1 for the working loop and Fs2 for the idler loop. It is emphasised that the parametric frequency differences here nominated as (fₚ −Fₛ₁) for the power loop and (Fₚ+Fₛ₂) for the Idler loop can be alternately arranged such that the Power loop can have native resonance greater than the pump frequency Fₚ as shown where Fₛ₁ is the resonant frequency of the load photo-emitter loop and Fₛ₂ is the resonant frequency of the idler loop:

Fₛ₁<Fₚ<Fₛ₂ and alternately Fₛ₂>Fₚ>Fₛ₁

This simple contrivance achieves unity power factor by adding a lossless leading or lagging pole to the overall transfer function to counter the load power factor of the power loop which is damped by photon production. It is noted Fₚ, the pump frequency provided by the HFAC bus determines the appropriate power loop resonance and the Idler loop resonance, wherein the power loop and the idler loop all have different resonances in the different contexts and it is mandatory that there are no shared harmonics between the three frequencies Fp, Fs1 and Fs2. One other design task is to determine appropriate turns ratios for the transformer. The reactive components of the step-down secondary side where Inductance is amplified and a capacitance is diminished in value by the square of the winding ratio have major effect where the individual turns ratios can determine the size of the resonant components and the Q of the resonances involved in the circuit.

The different resonance frequencies are all predicated by the advantageous auto-regulation function depicted in FIG. 4e and FIG. 4f. These graphs demonstrate the requirement of resonant frequency diversity to achieve the desired regulation effect. It is known in the art and prompted by this exposition that other complex relationships between resonances are able to be employed to further linearise the regulation effects disclosed herein but the simultaneous solution to unity power factor and secondary side regulation limit the solution field. In non-degenerate parametric phenomenon the solution field is a scalar field or set which is non-unitary given any one solution.

In this manner a plurality of such Luminaire loads can be attached to the bus and represent unity power factor which represents a resonant load with Q>>1 and consequent optimal power transfer efficiency.

In the device specified herein the importance of maintaining power factor is related to the intended extensive nature of the power projection requirement. Lagging power factor is a characteristic of most power distribution networks due to the need to drive inductive loads but at LFAC such as 50 Hz there is little practical benefit in respect of the cost to reduce the power factor to unity. With HFAC networks the maintenance of unity power factor is less costly and is beneficial to the extent of digital motor speed control by Link converters being highly efficient in energy usage. Benefit of unity power factor is not just found in energy consumption, but the addition of energy to such a network as specified herein by distributed power sources.

It is also noted that such resonance contains energy according to the energy of resonance as expressed:

$${Q}_{n} = 2 * π * ( \frac{( Maximum stored Energy , ℰ s )}{( Energy dissipated per cycle , ℰ diss )} )$$

Where it is evident both Idler Loop resonance and power loop resonance contain energy of resonance. Such a simplification of the expression above includes approximation of both loop currents being close to resonance but accumulating to the sum of both as determined by the unity power factor seen from the input port driven by the HFAC.

As shown in FIG. 4h and FIG. 4i where the Q of the loops are taken as peak values being proportional to the rms values:

$${Q}_{power loop} = \frac{Vresnode}{Vdrvr} = \frac{134}{41} = 3.27 ; \\ {Q}_{Idler loop} = \frac{VresIdler}{VdrvIdler} = \frac{70}{41} = 1.71 ;$$

Where assuming the same damping load diss being the LED array is shared equally:

$${ℰ}_{s} = \frac{0.5 \times ℰ diss * Qpwr}{2 * π} = 6 W \\ and {ℰ}_{idler} = \frac{0.5 \times ℰ diss * Qidler}{2 * π} . = 3.12 W$$

This resolves to the unique outcome that where the LED array is dissipating 23 W there is approximately 9.12 W stored energy of resonance, or 40% of the energy consumption remains in resonance. In a 100 qty Luminaire network of such luminaires there is almost one KiloWatt of stored energy.

This stored energy is unique to such a network. It is non-lethal and instantaneously available to achieve a stable response to transient loads such as luminaire switching ON/OFF and whole luminaire strobing such as may be beneficial to reduce power and certainly accommodates intra luminaire column current switching. Such regulation sustainment during transient perturbance of the Luminaire by intra-array or network impulse is a product of parametric design for these loads as for parametric amplifiers or timekeeping, these being recognised for low noise and stability.

The three frequencies of HFAC pump frequency and its interaction with the Power loop resonant frequency with the Idler loop frequency provides unity power factor allowing extensible networks reliant on a two wire HFAC bus.

FIG. 1a shows an example of prior art such as WO2013/102183 A1 cited as prior art. The multiplicity of capacitor components is evidenced and such multiplicity of capacitances able to carry 1 MHz 3 Arms are noted to be high power foil capacitors of large physical size and impractical for the high power usage of the subject innovation herein.

FIG. 2 shows the subject invention with emphasis on the colour discrimination between two colours where each is a unidirectional phase of the haversine photoflux. The current waveforms driven through the LEDs is shown in FIG. 3. The voltage source “V3” represents the High Frequency AC network bus energy source. Note the reference to the “zero phase” signal marker which is graphically shown as signals in FIG. 4. This signal marks the zero current phase also referred to as the “dark phase” of the current waveforms of the driven luminaire and used for synchronising multiple column current switching for multiphase creation for the magnetics of actuator drive or rotating motor phases. The “dark phase” is important for Optical Communication and the need for equalisation where the optimum wavelengths with best Signal to Noise Ratio (SNR) for VLC signalling can be determined while not in conflict with similar wavelength irradiation from the lighting or in the local photonic ambience. It is emphasised that the turns ratios of the transformer for Idler and power circuits are strategically chosen as is the value of Cres2 which is primarily determining the extent of the “dark phase”. Considering the Idler loop, it is known the Inductance is multiplied by the square of the turns ratio as seen from the primary of a step down transformer voltage, alternately the capacitance is divided by the square of the stepdown turns ratio. In many high power applications of this power transformation device the turns ratios are used to defray sensitivity and retain Unity power factor of the expected range of loading of the transformation device. It is emphasised the “dark phase” is not the only period wherein equalisation can occur. Optical communications wavelengths are highly reflective, marginally more so than 5G WiFi at mm wavelengths. As can be seen from FIG. 3 the reflective character of every wavelength can be determined at any time the specific wavelength is not being emitted. In FIG. 3 it can be observed that the reflectivity of the BLUE wavelength can be assessed while BLUE wavelength is in radiance phase without RED or other wavelengths in more practical multicolumn X-Y luminaires. Similar arrangements are practical for assessment of Fluorescence or phosphorescence, either at LIGHT/DARK transitions or DARK/LIGHT transition.

FIG. 2a shows a Parametric power transformation suited to lower HFAC voltage energy source. the stepdown turns ratio to achieve resonance providing correct voltage and energy to the node “ArrayDrv” is usually too great to allow a suitably sized capacitance value for Cidler. The step down turns ratio diminishes the effective capacitance offered by Cidler for resonance with Lidler on the primary side of the transformer. For a large Npri/Nsec ratio the capacitance Cidler is oversize even though the array drive voltage is usually lower than the HFAC bus voltage.

It is noted that there are two resonant frequencies operative as those more obviously shown in FIG. 2. The working resonance is Lres, Cres1, Cres2 and Cres3. The Idler resonance is LIdler and Cidler with the transformer providing the reactive component transformation as well as the voltage transforming according to the turns ratio. However for lower cost, lower power and lesser source energy voltage competence of this variant has merit where the leakage Inductance of the transformer is integrated with Lidler and is non-sensitive under the capacitance reflected to the primary side of the transformer. The capacitance C3 is an insensitive element to the functioning of the parametrics and serves as a safety block to preserve the circuit from inadvertent connection to 50/60 Hz systems. The system has high resilience to both high frequency and low frequency perturbation while absorbing energy from very narrow band frequency which allows Power Line Communications (PLC) very low insertion loss being at a much higher frequency than the energy absorbance at the 32.768 KHz of the example.

FIG. 2b shows the overt third current loop of the Idler frequency. In the manner similar to FIG. 2a the idler resonant inductance is combined with the primary winding leakage inductance. However the winding ratio Np/Ns2 is made independent of the working frequency loop. This permits the selection of the capacitor Cidler according to a contrived independent winding ratio. The magnetic circuit provides the milieu for the regulation effect of the multiple frequencies. This circuit is suited to high power regulation service and is the schematic for the hardware circuit used to generate the graphs of FIG. 4g and FIG. 4g-2. A further beneficial attribute of this configuration of FIG. 2b is that the magnetic linkage between core driven by Np can be split from the core driven by the resonant current windings of Ns2 and Ns1 secondaries in a manner a common “C” core can be wound with secondary windings on one half and primary on the other half of combined C core magnetic circuits. This then represents a contact “plate” which replaces an “electrical connection” for power transfer from the HFAC bus to a device. In the wet environment of horticulture simply attaching, by another permanent magnetic circuit say, a device to be powered to a contact plate is a significant safety benefit. This is safety and reliability issue which is central to the debate between electrical versus inductive powering of electric vehicle charging stations. Similarly, the HFAC two wire power transmission can have a ferrite E core arrangement such that “clip on” power can be available at any position the HFAC is propagated. This facilitates the positioning of sensors and monitors throughout a greenhouse to a high degree where such monitoring is required inter-folia. The topology of FIG. 2b has a very high primary winding inductance which is further complemented by the Lidler inductance.

FIG. 2c, FIG. 2d and FIG. 2e show a DC voltage variant and test results. The non-linearity of full wave bridge regulation creates no barrier to the constant power output character of the transforming device. The output of the voltage and current is shown in FIG. 2d and FIG. 2e. The FIG. 2d shows the maintenance of high power factor which is close to unity over a 500% load range variation. The FIG. 2e demonstrates the constant current nature of the parametric device by exhibition of a 45 degree slope across the 500% load variation where power is proportional to load impedance.

FIG. 3 shows the half rectified sinusoidal current waveforms common to each LED of the two columns. These waveforms are also the photo-flux photon density (radiant intensity) waveforms of this lighting method. It can be observed that the 16 uSec gap consequent of Fp=32.768 KHz shown between RED photon emittance sinusoidal pulses allows the replacement and insertion of another colour on a column of the same polarity. This is possible remembering that at zero current switchover the driving inductive elements do not detect a replacement column being inserted, as long as the column collation arithmetic is adhered to as shown in FIG. 9b which does not change the overall reactive impedance of the load circuit. However such damping changes of the system as occurring at swap-over of columns is adapted to instantly being similar to the modulation and failure resilience of the system depicted in FIG. 3a and FIG. 8e.

It is understood that LED devices represent very low reactive impedance and so represent suitable elements of purely heat dissipating, and photon producing sinks of energy for this topology.

FIG. 4 shows the marker pulse demarking the zero current phase of the LED drive, which also corresponds with the zero photoflux emission. This pulse coordinates the column swap-overs during the shorter zero current period caused by the charging of capacitor Cres2 and any communications service such as equalisation needed during this period. During this dark phase wavelengths can be emitted by various means by the modulator shown in FIG. 6 which is in-service to determine equalisation or some other sensing function such as determination of Fluorometry signal post irradiation of plant bio-mass, or other secondary radiation from curing processes of polymers. Such plant fluorometry is not diagnostically useful unless accompanied by spectrum control which allows fluorometry signal obtained post λred during λblue, say, and during extended periods of complete dark. Such extended multi-phase periods can be achieved within the control facilities by using SiC current rectifier diodes among the available columns for switching which emit zero photons. Such an arrangement allows provision of dark epochs of multiple wavelengths to accommodate the long period and short period varieties of chloroplast sourced fluorometry and other plant secondary radiation.

FIG. 4a depicts the manner the regulation is measured in order to represent the worst case of successive failures representing not just failure but also modulation depth at extreme asymmetry of power required for each of the two unipolar columns. Such simulator experiments examine the extent of regulation accuracy and verify the settings of Fₚ, Fₛ₁ and Fₛ₂, Cᵣₑₛ₁, Cᵣₑₛ₂, and Cᵣₑₛ₃ with Lᵣₑₛ and L_{idler} as determined by the design transfer function. As shown, all but one LED of one column are shorted first before commencing the failure simulation of the second of only TWO columns. The limitation of these demonstrations of embodiments to five LEDs demonstrates the worst case for regulation where step changes between failures is greater than with greater populations of LEDs. However more conventional populations are shown in FIG. 6 and FIG. 8a and exhibit the character of power distribution between columns.

It is emphasised that this form of regulation performs column current regulation correctly. A conventional constant current AC/DC PSU cannot regulate the two columns as shown in this disclosure generally. In conventional constant current LED drivers the column with one LED operational would draw all the current because of the forward voltage difference with the column with greater number of LEDs operational. The manner the conventional LED luminaire depends on the reliability of LEDs to sustain the integrity is a gross failure of intelligent design which was precipitated by limited knowledge of alternate topologies and the pressure on LED manufacture which fortunately resulted in the required reliability.

FIG. 4b depicts the effect of the parametric gap to achieve regulation in gross terms. This is the essence of the parametric effect which has regulation value as a topology. The value of [Fp−Fs] in absolute and unsigned magnitude where Fp is the pump frequency and Fs is the power loop resonant frequency driving the LED emitters. As graphed below in FIG. 4e, the excursion of LED current regulation is both positive and negative and as shown in FIG. 4f can be nominally zero meaning perfect regulation or zero excursion from nominal LED current over the load range from 10 LEDs being driven to 2 LEDs being driven and having zero drive current variation over this load range. Tolerances of manufacture can be refined to approach ideal regulation.

FIG. 4c depicts the unique character of the subject innovation specified herein as seen by frequency domain analysis where the greater understanding is to be had. If regulation is to be achieved the three loop currents must inter-operate in a manner parametrically cohesive to achieve the desired outcome—in this case being regulation and fast response to change or modulation of the load. The simultaneity of parametrics provides the ultimate response time constant but which makes iterative simulation and performance solutions difficult. The frequencies of the exchange between parametrically regulating load and the parametric projection of power is shown to have 2 dominant poles on the input voltage waveform. One is shown at 46 KHz and the lower one at 21.2 KHz. It is emphasised that this frequency domain analysis is done in conjunction with a network source impedance of complementary character.

The voltage locus against frequency, has such poles which dominate the entire network of such loads as herein specified. The frequency analysis shown in FIG. 4c includes the output impedance of the power supplies for the entire network allowing insight to the harmonic purity of the network power distribution bus.

Although circumscribed by resonant circuits, both for power insertion and extraction, any change of impedance threatening stability, such as runaway resonance, incurs the negative consequence of greater energy dissipation as can be seen from the frequency response of voltage as load complex impedances change.

The frequency Fp is positioned between these two dominant poles in such a way as the amplitude of response changes in compensation for load changes. It is emphasised that this energy interchange proceeds in accord with the unique character of phase change—which is approximating zero phase change across the frequency band between the two dominant poles of the network. As the load reactive impedance changes thus maintaining unity power factor as seen from the bus and consequently allowing the correct functioning of an extendable bus for addition of power by distributed power sources with such complementary source impedances and the extraction of power by such unity power factor loads specified as herein. This example embodiment in simple form is more practically exemplified by continued addition of luminaires as those examples depicted in FIG. 6 and FIG. 8a among other examples herein.

This phase management and pole transit shown in FIG. 4c is a function of Lres, LIdler, Cidler, Cres1, Cres2 and Cres3 and all constitute the regulation response to changes of load or modulation as shown in the bode plot of FIG. 4e. For this reason, consistent with other amplification strategies benefiting from distributed energy active in the system of fast response, low noise and associated stability, the system specified herein enjoys the functional advantages of other parametric systems.

FIG. 4d demonstrates simple time domain examples of unity power factor where the Luminaire appears as a purely resistive load to the network, and reactive power is not observable from the HFAC network because of cancellation of complex conjugates. However as above described such parametric networks as herein deploy large energies contained in the resonances of loads, but it exists in the resonant loop circuits internal to the Luminaire. It is a unique feature of such networks of luminaires, or other loads, as herein described require distributed and non-lethal energy throughout the built environment where employed. HFAC power frequencies projected through the built environment evoke zero neurological response save that of a simple sub-acute burn sensation.

FIG. 4e shows graphing of regulation as a product of the parameter [Fp−Fs] with the changing load represented by shorting the LEDs of the array shown in FIG.2. This demonstrates the ideal operating point for such an array is with Fp−Fs=4500 Hz, but shows the regulation character at different settings of Fp−Fs for a chosen parameter setting for the other components of the circuit. It is noted that other determinants such as Cres1−Cres2 represent different character of regulation, such as regulation for luminosity by increasing LED current or LED lifetime optimisation by maintaining LED current of survivor LEDs after failure or in consequence of modulation.

FIG. 4f depicts graphing of the percentage regulation error against the parametric gap from 2.500 KHz through to 6.000 KHz lower than the nominal 32.768 KHz pump frequency as is indicated by the abscissa stating the axis quantity is “lagging” as depicted in FIG. 2 given the other parameters are the same as graphed in FIG. 4e.

This graph shows the optimal setting for the load circuit loop resonance is approximately 4.400 KHz below the pump frequency of 32.768 KHz meaning the load loop resonant frequency is 28.368 KHz. The interrelation of the example three frequencies can be alternately arranged as mirrored for leading power factor with appropriate changes to the component values as stated above where in the example of this graph Fs1<Fp<Fs2 where Fs1 is the working loop resonant frequency, Fp the pump frequency supplying energy and Fs2 is the idler frequency. As stated it is possible to reconfigure the settings and component values such that an alternate mirror function exists as Fs2<Fp<Fs1

FIG. 4g shows the effect changes of loading on the schematic of FIG. 4d have on the power factor. This response is commensurate with expectation after noting the zero phase bordered by the frequencies of the dominant poles of the network as shown in FIG. 4c. The flat phase change over the current output regulating extent of the innovation herein provides a necessary and complete condition for the ability of the device to present unity power factor to the energy source for the innovation to function. For load impedance changes reflecting resonance frequency changes the amplitude modulation moves to effect regulation of say current, the phase change is close to nil, indicating the power factor of the load seen from the HFAC power source will remain constant over the degree of load impedance change as shown in FIG. 4g. However at unity power factor setting both the large and small wattage compensation for unity power factor “dither” about the point PFC=1. These low frequency dither changes do not exhibit themselves on PFC current modulation nor do they evidence any disturbance on Power Factor Measurement nor do they create any instability on the regulated load being stabilised by the source impedance of the power source for Fp and the stochastic balance of resonant power distribution in the network. This is expected by the exchange of energies between the idler current loop and the working loop dissipating power of classic non-degenerate parametric phenomenon. PFC measuring instrumentation adjustment of integration period shows power factor averaging to unity by reason the dithering is statistically averaging to unity. At higher loads the Idler loop stabilises and ceases to cyclically transfer loop energy between the power loop and the Idler loop showing the circuit of FIG. 2b has the most stability at high load power and also so the greater power transforming capability.

It is to be noted that the regulation “droop” and the Power factor “droop” are countervailing. A positive droop on regulation results in a negative droop on the power factor as load varies. This predicts a set of parametric component values exists which provides zero droop of both regulation error and power factor in accord with the theory though determination of the value settings would be asymptotic in the light of material qualities and manufacturing tolerance especially the quantised nature of magnetic winding. Power factor is shown driven to within 0.003 of unity concurrently with a regulation error of 1% over the load wattage range. For large networks of many such load interfaces, the power factor would be of stochastic values and present minimal gross bias.

FIG. 4h depicts the resonance quality factor “Q” as discussed above as evidence of the positive energy storage in the resonances of such an HFAC network of distributed loads. This attribute has numerous benefits the first of which is the ability of a network to have universal response over its extent to perturbations and utilises the energy storage of say, 40% of a network as above. These Q figures are represented in the discussion above.

FIG. 4i Shows the circuit schematic producing the waveforms of FIG. 4h. Of note is the characteristic shape emerging from the V(resnode) waveform of the degenerate parametric frequency of energy transfer Fₛ₁=2*Fₚ. This characteristic waveshape is a muted version to be expected in non-degeneracy also. This characteristic is the gradient inflexion point immediately succeeding the peak voltage where the capacitance has exhausted the inductive field energy and represents the point at which the inductance has greatest voltage across it at the same time the LED Ifrwd currents see the LEDs as open circuits providing the smaller capacitance of Cres2 for loading and delaying LED current. This alteration of load impedance during an HFAC cycle in the analysis of parametric theory is termed the “parametric gain” and accounts for the high Q of the resonances to some degree irrespective of the degree of dissipative damping incurred driving the LEDs.

FIG. 4j depicts the photoflux density relationships between Ifrwd(dc) and Ifrwd(hfac) for the same heat dissipation. Such circuits as shown in FIG. 6 are known by test and peer review to function at least to 2.5 MHz and are shown to produce disproportionate interactions with actinic sites of a Cerium phosphor salted with Europium, where the latter material extends the “persistence” or decay time constant of the phosphor amalgam. Two international Test Labs reported a 14%, and a 5% gain in secondary radiation for equivalent Ifrwd(rms) currents between the unsalted Cerium and the Cerium salted with Europium phosphor. This is attributed to the greater peak photoflux density being of greater capacity to interact with actinic sites. The average LED current of the subject array above the Ifrwd(dc) is 21% greater as shown in FIG. 4j. This advantage is considered strategically important for human habitat lighting and plant photosynthesis. The advantage being that “white” made from the component spectral components avoids the loss of efficiency of conversion from the single 450 nm phosphor excitation and in raw sequence of spectral components described above has added capacity by the nature of the waveform to be perceived at greater intensity. Alternately to the use of phosphor secondary irradiance the innovation as described herein can better pump phosphor so achieving power reduction for the same Lumen irradiance. Even further such a function as TDSI specified herein may obviate the use of phosphor secondary emission “stokes shift” phenomenon and achieve both better colour control and lower power requirements for the same illumination effect.

FIG. 5a Depicts the simplicity of column Time Division Multiplexing in elemental form. The FIG. 5a and FIG. 5b show both the consequent waveforms and the related circuit in simulation. This drawing demonstrates the ability to physically multiplex LED photon emitter elements in a circuit and consequently time division multiplex their respective wavelengths in the composite irradiance of the device while at full power without switching currents in the inductive circuit. This is only practical when switching columns during the “dead phase” of the LED array as directed by the zero phase signal of FIGS. 2,4 when there is zero current in the LED array columns being switched into circuit activation and out of circuit activation. It must be recognised that two same polarity columns can be swapped at any time the alternate polarity column is conducting. This is a much easier switch transition with longer periods within which to execute other functions such as fluorometry sensing and measurement. The usual switching timing is between LED emissions of the same polarity but here is shown the ability to switch bidirectional columns during the dead phase timing provided by the “zeroPhaseSwitch” signal of FIGS. 2,4 even at 500 KHz where each 180 deg phase of the Ifrwd(HFAC) represents a luSecond strobe of photoflux.

FIG. 5c shows the emittance of a luSec photoflux shot from the circuit of FIG. 5b from LEDs driven by 1.5 Apk pulse current per column from among an array driven at 500 KHz. The photo impulse is shown from LED D25 shown in FIG. 5b but represents a luSec photo-pulse from the entirety of the column of 10 off 1.5 Apk LEDs. In an array of multiple columns, a selection of extra columns can be fired with the 1 uSec pulse. While this is an extreme radiance it is reported that plant chloroplasts respond to such intense bursts of photoflux and respond in different measure to different wavelengths administered for different periods for different species. The switching arrangement exemplified in simple form of FIG. 5b can be controlled by a processor with signalling of the instant phase of the system appropriate for which column to select for the colour/wavelength to be emitted according to its programming. A switch matrix is programmed into a programmable logic device for non-volatile configuration which has inputs of phases and zero phase signal. The successive variety of patterns to be established of irradiance is then switched into the composite wavelength array and this is self evidently able to be a dynamic process in response to biofeedback from such as fluoroscopy, temperature et al and even the stages of growth as appropriately determined by knowledge such as from a plant growth library.

FIG. 6 shows a more practical larger X-Y array of LEDs of parametrically regulated lighting X-Y array pumped at 1 MHz. It is usual for conventional constant current DC driven luminaires to have multiple column arrays, say of X column LEDs in each of which there are Y LEDs and summing to perhaps hundreds of LEDs. In contrast to conventional constant current driven DC LED arrays which redistribute current after any short or open failures, there is an uncontrolled initiation of a failure cascade. However, the subject parametric regulated X-Y array has column current instantly regulated by this simple LED driver even to the extent of facilitating 100% modulation of intra column LED groups by the switch shown to be shorting D15, D17 and D19 completely which is of one wavelength and swapping in another so effecting half of a differential amplitude modulation technique. These waveforms consequent of this 100% modulation are shown in FIG. 7 next. The schematic shows a unidirectional column containing LED D21 being modulated by a differential modulation system exemplified by V2 switch control. In this circuit LEDs D15,17, and 19 are activated alternately with LEDs D13,D1,D3 as shown.

It is noted that there are two methods of photo-flux pulse emittance. One can be said to be intra-column and the other relating to whole column activation can be referred to as inter-column. The use of Inter-column activation allows the greater number of LEDs to be used for a photo-pulse.

It is noted that such gross modulation depth is not normally required and S1 of FIG. 6 can be a complex modulation chip performing a role as an OFDM baseband modulation chip for visual light communications. This is a simplification for determining what radiance is required, and this may be determined by the number of mini-LEDs suited for the high frequency required. Existing high power LEDs have large junctions and 20 MHz modulation is a practical limit. This circuit allows selection of larger numbers of smaller LEDs as columns or sections of columns to perform modulation depths in array extensions and inclusions such that the high frequency radiance required can be emitted. The role of “lighting” can then be to communicate with the devices of the IoT complete with self calibration by equalisation and also supply power with less RFI and smaller more reliable power transformation. Such modulations discussed immediately above are always included in considerations benefitting from the high Signal to Noise ratios discussed previously where wavelengths modulated are synchronised with the wavelength sequencing of TDSI defined herein where signal and generated illumination irradiations do not conflict contemporaneously at the same wavelength.

FIG. 7 shows the swapped LED currents controlled by the signal “swsig” of FIG. 6. It is emphasised that where columns can be swapped judiciously to benefit from TDSI sequencing in respect of timing, the modulation intra column such as executed by “swsig” of FIG.6 can be performed without respect of phase given due regard for inductive response. The modulation of such LEDs can be timed to be executed during radiance phase synchronised with the chromatics of TDSI and are able to modulate appropriate complementary colours colours emulating the baseband signals of OFDM. The transparency of the parametric device herein to Phase Shift (PSK) modulation is attractive and by such known modulation techniques a massive MIMO system for the built environment is appropriately facilitated.

FIG. 8a shows the extent of an arbitrary shorting of LED elements that is accommodated by the regulation response competence of the subject innovation herein even when driven at 500 KHz which provides photoflux pulses of luSec. In each column it is noted adequate regulation and allowance for different Vfrwd of all LED style junctions emitting different colour/wavelength of LEDs. The extent of failure resilience is an example of the degree of radiance intensity that can be modulated for Visual Light Communications (VLC). It is also noted that the understanding of this degree of variable Vfrwd of the LEDs according to the wavelength, and also the accommodation of high levels of at least amplitude modulation is because each end of a column pair is a capacitor and each column can be considered driven by the difference between two AC loads as depicted in FIG. 8c even to the extent ONE of two such columns has only 20% of the LED population serviceable as shown in FIG. 8d.

FIG. 8b shows the waveforms remaining regulated in each column of the schematic of FIG. 8a. It is noted that this represents correct column regulation and a similar X-Y dimension of DC driven LEDs would not be shown to be correctly regulating current and would fail immediately consequent of some columns such as the column containing LED D45 would be drawing disproportionate current through its three active LEDs in comparison with the column containing LED D65 which requires current for 10 LEDs and so holds off any voltage less than 10×Vfrwd=3.2×10=32 volts to pass current. The column containing LED D45 which has only three active LEDs provides a current pathway with a forward voltage of only 3×3.2=9.6 Volts which would cause an instant catastrophic failure when such current from the entire array is redistributed into the column of only three active LEDs when driven by conventional constant current DC PSU.

In contrast, the parametric regulation shown in schematic FIG. 8a preserves regulation within LED safe operating area even under extreme shorted elements as shown in FIG. 8a which results in preservation of lifetime and serviceability for such a luminaire almost to the lifetime of the most reliable LED component, whereas a DC driven luminaire of the same LED components only lasts as long as the lifetime of the least reliable LED element. The statistics analysis demonstrates the serviceability lifetime of the luminaire to be at least ×10 the MTTF of a constant current drive of an LED luminaire.

FIG. 8c shows the manner the failure asymmetry of the parametric LED array of FIG. 8d is accommodated. The waveform of FIG. 8c is a depiction of the instantaneous voltage across the LED array between the node “ArrayDrv” and the node “ArrayEnd”. The LED load circuit behaves as would be expected of an AC coupled load. The asymmetry of the Vfrwd voltage to drive equal current in each direction is accommodated by the bias between Cres2 and Cres3 as seen on the waveform of FIG. 8c. It is noted the shorted side with only LED D12 being driven is forward biased by only 3.5 volts peak for chosen nominal Ifrwd. The column containing 5 LEDs is automatically biased at a Vfrwd of 17 volts so assuring that each column polarity is driven with equal current irrespective of the number of LEDs shorted. This AC coupling is ONE regulation function included in this topology of parametric regulation.

FIG. 8d shows the circuit schematic generating the waveforms of FIG. 8c. It is noted that the diodes D1 and D2 are required to avoid reverse bias of the two unipolar columns. The asymmetry is seen shorting 80% of one of the two columns, yet it is noted the currents in each column are equal and regulated even under the circumstance the damping has changed radically in this multi-resonant non-degenerate parametrically compensating circuit.

FIG. 8e shows the second parametric effect which assists control the damping response of the schematic of FIG. 8b. The presence of the capacitor Cres2 inhibits the rate of climb to greater Vfrwd per forward voltage phase in comparison to the smaller Vfrwd needed for the forward bias of LED D12. During this extended period to charge Cres2 to the higher voltage the inductor Lres increases current and stored field energy which drives the greater power into the LED D13 column. It must be noted that there is a power differential notwithstanding the current equality between the two unidirectional columns by virtue of the voltage, in fact the power ratio is 5:1 for equal currents driven in each unipolar column. The design of various length of columns as determined by LED numbers per column needs to account for this power differential in determining the relative values of all resonating participant components but the voltages never exceed the balanced voltages used for normal operation of the bi-polar column pair.

The third significant parameter determining regulation is the frequency domain change of amplitude as shown in FIG. 4c. Although the phase change is minimal as the resonant frequency changes the LEDs represent real impedance which changes as they are shorted representing changes in the two natural frequencies with Cres2 in circuit and a second natural frequency when both are in circuit. The voltage across the array which drives the LED current represents a rate of charge delay between charging of Cres2 and Cres3 and as such it is one parameter which is taken to determine the current limits for the LED components. The two natural frequencies have different gain responses according to the bode plot of amplitude of FIG. 4c as the column LED quantity changes by design or by failure or by modulation which is compensatory.

FIGS. 9a,b shows the arithmetic of successfully combining columns. This is a necessary step for the column switching to be successful. Referring to FIG. 6, the resonant capacitors Xuf, YuF and at the distal end, ZuF are ¼ values as are needed for the combined column array of FIG. 9 as might be expected when FOUR columns are concatenated into ONE array to preserve the reactive components driving the same damping as represented by the LED array. It is observed in the waveform diagram that the zero current phase allowing column switching shown in FIG. 5b can be detected from the zero current marker of I(4×Cr2) as depicted in FIG. 2.

It is noted that the zero current switch pedestal is also at a point where there is zero voltage change on the capacitors Cres3 and the unused columns are normally tied to the Cres3 voltage by drivers of the column switches or dimming or energy modulation in the general application sense.

FIG. 10 shows a graphic depiction of an absorption spectrum of a plant, and below this absorption profile is a representation of the proposed irradiation as programmed for the device disclosed herein to match the shown absorption profile of the example plant with amplitudes matching the propensity of the plant to benefit by photosynthetic use that wavelength. The variable benefit of each wavelength to the chloroplast of the plant is represented by the “Photosynthetic Active Radiation” (PAR) absorption profile used widely by the horticulture industry to discriminate the uMol/Watt growth assistance competence of a radiated spectrum. In the example of FIG. 10, each wavelength to be emitted has a “dT(n)” time increment term superposed. This term relates to the discussion above where there is a known time period wherein the plant chloroplast is optimally supplied photons and this period is found by experiment for each plant and is related to hydration, nutrients, gaseous environment importantly CO₂, temperature and other factors including the history of these parameters. In the example case this period is found to be 150 uSec wherein a single 1% duty cycle photon flux at wavelength of 668 nm has the same growth effect as 150 uSec at 1% of the radiant intensity used for the 1% duty cycle pulse.

In the manner described previous these dT time increments can be 1.5 uSec duration for each wavelength such that this scan of 8 wavelengths can be repeated 12 times within this period of 150 uSecs and radiate the same photon quantity onto the plant chloroplast. The benefits are that assuming the photo-effect of all wavelengths to be equal for the argument, the reduction in average photon requirement will be (⅛× 1/12) of the original 1% 668 nm strobe PFD given the minimum pulse period of 1.5 uSec is known and also the time constant of 150 uSecs for the photon replenishment within the plant chloroplast is known.

Such simple arithmetic must be consistent with the integrating temporal unit of a Watt POWER which is a joule of energy consumed over one second and the quantum efficiency stated for any LED is not challenged. The innovative advantage herein is that such spectral dissection implied in the TDSI method is enhanced by the demonstrated disproportionate efficiency of high peak flux density to activate actinic sites of chemical compositions and further enhanced by the ability to vary such spectral components dynamically in a bio-feedback assembly which can be adapted for a range of photochemical application.

1. A power transforming adapter device comprising a transformer with a primary winding driven by a high frequency AC (HFAC) sinusoidal power source and with two or more secondary windings each driving secondary circuits
wherein each secondary circuit is a series connected inductor and capacitor second order resonant circuit which resonates at a continuous sinusoid frequency different from the frequency of the HFAC power source,
wherein a first secondary circuit contains no overtly dissipative elements,
wherein all other of said secondary circuits include a rectified dissipative load,
wherein the currents in the secondary circuits inter-modulate by magnetic means in the core of the transformer and with reactive components in the secondary resonant circuits external to the transformer,
wherein the power to said dissipative load element is regulated by said parametric interaction among the secondary circuits and the HFAC source,
wherein the secondary circuits and the HFAC source together form a non-degenerate parametric circuit system.

2. The device of claim 1 wherein one or more resonant secondary winding circuits regulates power to rectified array columns of serially connected LEDs or other dissipative loads by said parametric means such that column currents remain regulated after shorted failure of LED elements or functionally appropriate variation of loading within such columns without switching means.

3. The device of claim 1 which auto regulates the Power Factor of energy absorption from the HFAC bus to approach unity without switching means so allowing arbitrary HFAC power distribution bus extension by further addition of said power adapter devices which preserve power transfer efficiency over distributed cumulative adapter loading.

4. The adapter device of claim 1 which provides optimal power transfer from HFAC bus to adapter load dissipation by retaining unity power factor with concurrent regulation of power to varying loading without need of switching means preserving low harmonic distortion of the HFAC power distribution bus and extending MTTF of such regulated power areal distribution by minimisation of semiconductor component requirement and reducing cost of production.

5. The adapter device of claim 4 where such resonant circuits of one or more power dissipating secondary circuits contain LED emitters or similar unipolar emitters in apposite half wave rectified pair serial arrays within each column where consequent of AC coupled circuitry preserve safe operating regulated half wave drive of unipolar arrays where differential column ignition voltages are caused by mixed wavelength emitters with different forward voltage or consequent of LED shorting failure or consequent of design requirements for column radiant power or to meet current drive strictures of manufactured component use.

6. The adapter device of claim 4 where such half wave rectified, regulated, LED column pairs of apposite polarity serially connected LEDs are replaced by a single unipolar regulated column of LEDs by means of full wave rectification wherein such consequent single polarity current drive is of haversine form and may or may not be filtered by parallel capacitance to the LED array load to effect low ripple DC current LED drive.

7. An adapter device as in claim 6 where half wave rectified loads of arbitrary nature being passive or reactive with large time constants of activation relative to the HFAC frequency being of opposite polarity are replaced by a single column of uniform polarity by means of full wave rectification wherein such consequent single polarity current drive is of haversine form and may or may not be filtered by parallel capacitance to the arbitrary load to effect low ripple DC current drive of a single unipolar arbitrary load.

8. The device of claim 7 wherein the components are LEDs, wherein a plurality of linear arrays of components are controlled by switching currents from one column at appropriate phase to an alternate column during the non-linearity required of parametric regulation at the zero current crossing dead phase interval to alternate LED luminance from one array to another under programmatic control at a maximum frequency of such alternation equal to twice the frequency of the HFAC drive frequency.

9. The adapter device of claim 8 where such LED column alternation of emission of different photonic wavelengths are performed in programmable sequences repeated once or in multiplicity to temporally disassemble the spectrum required for a photochemical reaction within the time constant characteristic of such photo-chemical reactions for completion or substantial completion.

10. The adapter device of claim 9 wherein one array alternated within a sequence of switched arrays comprises non-photo-emitting diodes, and wherein a dark 180 deg phase of the HFAC power waveform is thereby created.

11. A device as in claim 8 where such programmatic controlled sequential wavelength photoflux emission is synchronised with reception of signalling systems for reception of optical signals with high signal to noise ratio, consequent high bitrate consequent of minimal interference between radiated signal and radiated illumination wavelengths.

12. The device of claim 11 wherein the received signal is the result of fluorescent emission.

13. The device of claim 9 where such HUE and individually perceived optimal white illumination can be created by high frequency alternation of spectral lines within the time constant of flicker fusion for human sight.

14. A device of claim 11 with the synchronism of emission determining optical signal reception in momentarily absent spectrum where the signals received are from transponders or emitters in free space transmitting optical data signals with high Signal to Noise Ratio.

15-16. (canceled)

17. An adapter power transforming device of as in claim 4 which by said rectification of HFAC at unity power factor provides a suitable DC voltage to an existing 50/60 Hz LFAC device, either actuator or instrument, with a full wave rectifier input or with a power factor controller input.
